(19) United States
(12) Patent Application Publication
(10) Pub. No.: US 2026/0212338 A1
(43) Pub. Date: Jul. 23, 2026

(54) SYSTEMS AND METHODS FOR DATA AUTOMATIC UPDATES AND SYNCHRONIZATION

(71) Applicant: MyCard Inc., New York, NY (US)

(72) Inventors: Kieran O'Reilly, New York, NY (US); Ruben Nurmohamed, Saint Charles, MO (US); Olav Alberts, Leersum (NL)

(21) Appl. No.: 19/237,975

(22) Filed: Jun. 13, 2025

Related U.S. Application Data
(60) Provisional application No. 63/748,630, filed on Jan. 23, 2025.

(51) Int. Cl. G06Q 20/22; G06Q 20/40; G06Q 30/0601; H04L 9/40

(52) U.S. Cl. CPC G06Q 20/227; G06Q 20/4014; G06Q 30/0625; G06Q 30/0643; H04L 63/08

(57) ABSTRACT

A computer-implemented method and system for managing and updating default payment-account-on-file (POF) across multiple merchant systems through a unified interface. The system generates a personalized list of merchant systems associated with a user based on profile data, prompts the user to authenticate through a credential management account, and retrieves stored credentials for multiple merchant platforms. The system extracts and processes merchant system information from the retrieved credentials to dynamically modify the displayed merchant list, enabling users to select specific merchants for POF updates. Upon user selection, the system automatically transmits appropriate credentials to authenticate with the selected merchant systems and, following successful authentication, sends instructions to update the default POF to a user-specified payment account.

### CROSS-REFERENCE

This application claims priority to U.S. Provisional Application No. 63/748,630, filed Jan. 23, 2025, which application is incorporated herein by reference in its entirety.

### BACKGROUND

Many merchants and vendors receive payment from their customers using online payments. Credit card or debit card payments may be performed online by providing the required information to authorize payment. Online payments offer ease of use for the customer, as the customer does not need to rely on traditional methods of payments such as visiting a brick-and-mortar store or mailing in a check. Many merchants offer the option of storing payment account information on file so that the customer can make payments easier and quicker the next time. This can be particularly helpful for recurring purchases such as monthly bill payments or frequent and irregular payments such as when shopping online at the merchant store.

### SUMMARY

Switching the default payment-accounts-on-file (POF) at vendor websites can pose a challenge for consumers, card issuers, and merchants/vendors alike. For consumers, consumers have to manually visit each individual website, log-in, and update the default POF. This can become a tedious and daunting task, as the consumers may have to spend hours upon hours trying to update their cards, and the time consumption may be compounded if the consumers do not have their log-in information readily available for websites that they do not frequently visit. For card issuers such as banks and other financial institutions, it is desirable for card issuers for the consumers to use issuer's cards as much as possible so that they collect fees from use. However, if the consumer has to manually change each default POF, the consumer may not do that or only do it for a subset of merchants that the consumers use, which can lead to lower usage. And finally, merchants want to make sure the consumer has an active POF that they are using, rather than for example a card they don't use often or at all which may be in danger of being canceled, and a canceled card can lead to delayed payments or even canceled subscriptions.

Accordingly, there is a need for systems and methods for consumers to easily switch cards on file. Provided herein are systems and methods that enable consumers to seamlessly switch their default payment-account-on-file (POF) at multiple merchant websites. A payment account switcher interface can be provided on the website of the card issuer. The payment account switcher interface may provide a list of merchants that are commonly used to the consumer so that the consumer can select which merchants they want to switch the POF. The consumer can log-in to their selected merchants by providing log-in information which may be kept secure. The systems and methods disclosed herein can be adapted or made compatible with a variety of merchants and vendors'websites.

In one aspect, disclosed herein is a computer-implemented method for changing a default POF for a user on a merchant system, comprising: receiving, from an issuer system, a request to change a default POF, wherein the issuer system is configured to manage an account that the user selects to use as the default POF; predicting, one or more merchant systems associated with the user and displaying the one or more merchant systems to the user for the user to select to change the default POF; upon receiving a user input indicative of selecting at least one merchant system, receiving, from the user, credentials for authenticating the user's account on the at least one merchant system and transmitting, to the merchant system, the credentials to authenticate the user's credentials; receiving, from the at least one merchant system, an indication that the user's credentials for the user's account have been authenticated for the at least one merchant system; and transmitting instructions to the at least one merchant system to change the default POF for the user's account to the account that the user selects to use.

In some embodiments, the default POF includes a payment account that is saved on the account associated with the user on the merchant system and used to make purchases by the user.

In some embodiments, changing the default POF includes changing from a first payment account to a second payment account on the merchant system for future transactions made by the user.

In some embodiments, transmitting instructions to the merchant system to change the default POF comprises transmitting an API call to the one or more endpoints associated with the merchant system to perform the change.

In some embodiments, transmitting the API call comprises transmitting payment account information related to the payment account to the merchant system.

In some embodiments, transmitting instructions to the merchant system to change the default POF includes instantiating a web browser and simulating a direct interaction with the merchant client on the web browser.

In some embodiments, transmitting instructions to the merchant system to change the default POF includes monitoring data traffic to and from the merchant system and simulating manually changing the default POF.

In some embodiments, the payment account information includes information related to a card number, an expiration date, and a verification code.

In some embodiments, the payment account information is contained within a token.

In some embodiments, the method further comprises, after receiving the indication, storing (i) user information including one or more of name, address, or phone number and/or (ii) the payment account information.

In some embodiments, the method further comprises, prior to receiving the request, providing the user, via the issuer system, a payment account switcher interface to enter a set of information related to the account associated with the user.

In some embodiments, the method further comprises providing the user, via the payment account switcher interface, a list of merchants that the user can select.

In some embodiments, the list of merchants is determined based at least in part on popularity of the merchants, relevance determined based at least in part on a characteristic of the user (e.g., age, geographic location, etc.), and/or a list prepared by the issuer system.

In some embodiments, the method further comprises, prior to receiving the request, receiving an indication that the user has the account with a merchant associated with the merchant system.

In some embodiments, the method further comprises transmitting instructions to the issuer system to display an image, text, or other indication that the user has the account with the merchant.

In some embodiments, the method further comprises, prior to receiving the request, providing the issuer system a software development kit (SDK) to customize or create the payment account switcher interface that is shown to the user.

In some embodiments, the method further comprises, prior to receiving the request, when the user is using a mobile device: generating a merchant webview of a login page associated with the merchant, wherein the merchant webview is a custom log-in page associated with the merchant; and transmitting instructions to the issuer system to display the merchant webview to receive log-in information from the user.

In some embodiments, the method further comprises, after transmitting the instructions to display the merchant webview, monitoring the merchant webview for changes in cookies and/or URLs to determine when the merchant is authenticated.

In some embodiments, the method further comprises, during the monitoring, detecting that the user has successfully logged in to the account for the merchant.

In some embodiments, the method further comprises, after generating the merchant webview, transmitting instructions to the issuer system to: generate a log-in page that is overlaid over the merchant webview; receive the credentials of the user via the log-in page; transfer the credentials to the merchant system via the merchant webview; and submit the credentials to the merchant system.

In some embodiments, the method further comprises, after submitting the credentials to the merchant system, monitoring authentication of the credentials and providing any error messages, captchas, one-time password (OTP) requests, etc. to the user.

In some embodiments, the method further comprises, after providing any error messages, captchas, OTP requests, etc. to the user, receiving a response from the user and transmitting the response to the merchant webview.

In some embodiments, authenticating the user's credentials comprises, when the user is using a desktop or laptop computer: using an HTTP reverse proxy that shows a merchant webpage on to the user on a domain that is different from a merchant domain associated with the merchant; and providing one or more requests received from the user to the merchant domain based on one or more requests on the merchant webpage on the different domain.

In some embodiments, the method further comprises using an HTTP forward proxy between the issuer system and the merchant system to control data that is sent to the merchant system.

In some embodiments, authenticating the user's credentials comprises, when the user is using a desktop or laptop computer: hosting a remote browser on a processor other than the desktop or laptop computer used by the user, wherein the remote browser has a URL set to a merchant webpage; streaming the merchant webpage to the desktop or laptop computer used by the user for authenticating the credentials.

In some embodiments, the steps of receiving the request, receiving the credentials, transmitting the credentials, receiving the indication, and transmitting the instructions to the merchant system are performed using APIs, webhooks, and/or programming instructions such as Javascript.

In some embodiments, the webhooks are configured to monitor for one or more events including the user access or opening the merchant on the payment account switcher interface, authenticating the user credentials for the merchant system, updating the card on the merchant system, or completion of changing the default POF to the card.

In some embodiments, during receiving the credentials, receiving from the user cookies, an access token, session data, JSON web tokens, etc. through the payment account switcher interface.

In some embodiments, the method further comprises collecting or storing transaction information and/or profile information in a database.

In some embodiments, the merchant system includes an e-commerce system, a ridesharing system, a food delivery system, a travel system, a streaming system, a gaming system, etc.

In some embodiments, the transaction information comprises seller information, pricing information, product information, ridesharing information, driver information, flight information, hotel or lodging information, etc.

Non-transitory computer-readable media comprising executable instructions that, when executed, cause at least one computer processor to perform any of the methods discussed herein.

A computer system comprising a memory storing computer-readable instructions and at least one processor configured to execute the computer-readable instructions that are configured to perform any of the methods discussed herein.

### BRIEF DESCRIPTION OF THE DRAWINGS

A better understanding of the features and advantages of the present disclosure will be obtained by reference to the following detailed description that sets forth illustrative embodiments and the accompanying drawings of which:

FIG. 1A and FIG. 1B shows an example of a system for implementing card switching in accordance with some embodiments; FIG. 1C shows an example of account updater component.

FIG. 2 shows an example of a process flow for switching cards using the payment account switcher interface, in accordance with some embodiments.

FIGS. 3, 4, 5, and 6 show example screenshots of a user interface of the payment account switcher interface on a mobile device, in accordance with some embodiments.

FIGS. 7, 8, 9, and 10 show example screenshots of a user interface of the payment account switcher interface on a computer, in accordance with some embodiments.

FIG. 11 shows an example of a computer system that is programmed or otherwise configured to implement card switching, in accordance with some embodiments.

FIG. 12 shows an example screenshot of a dashboard for monitoring default payment accounts, in accordance with some embodiments.

FIG. 13 shows the mass switching component implemented in the backend in communication with a credential management system for a mass switching feature.

FIG. 14 shows an example of a webview displaying an option for a user to log into a credential management account or a single sign-on (SSO)account.

FIG. 15 shows an example of user interface for subscription management.

FIG. 16 shows an example of SKU-level transaction data.

FIG. 17 shows an example of webview or GUI of a transaction link module.

FIG. 18 shows an example of using transaction link module to automate user cashback rewards, ensuring faster processing and eliminating manual receipt uploads for users.

FIGS. 19-21 show examples of a one-click agentic shopping feature provided by the system herein.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the present disclosure. It should be understood that various alternatives to the embodiments described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

### System

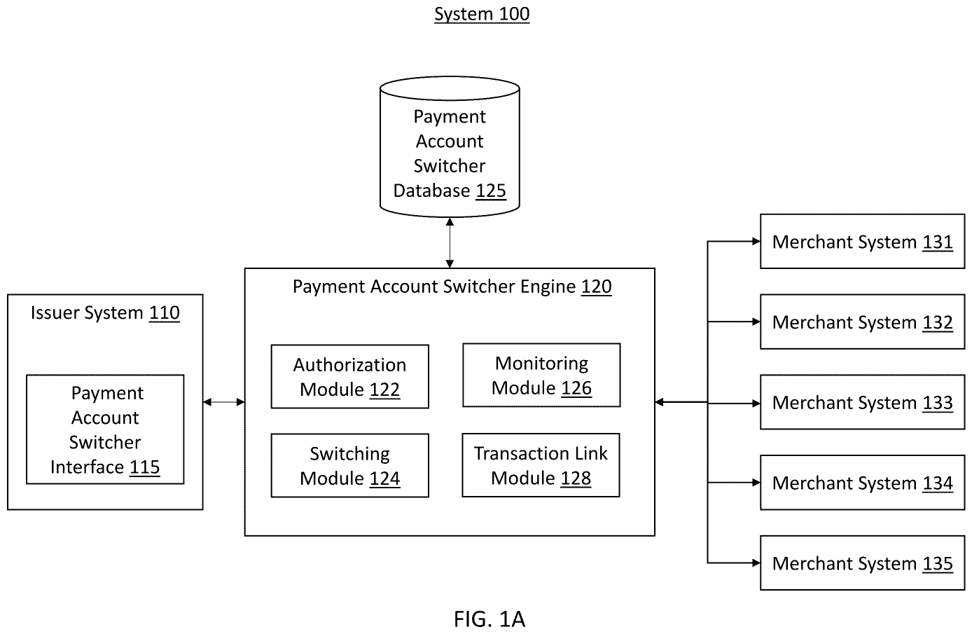

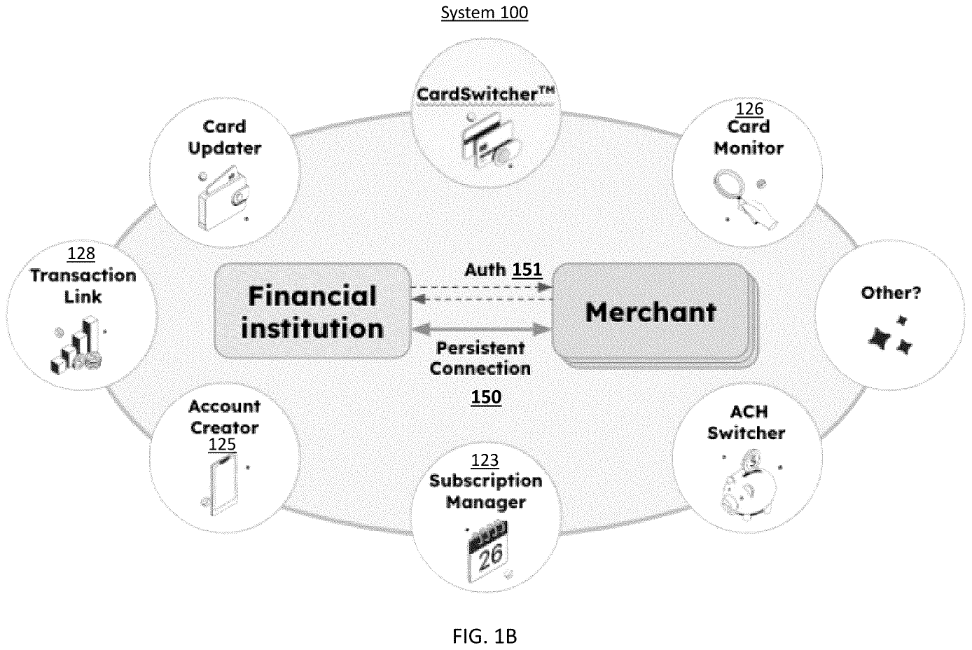

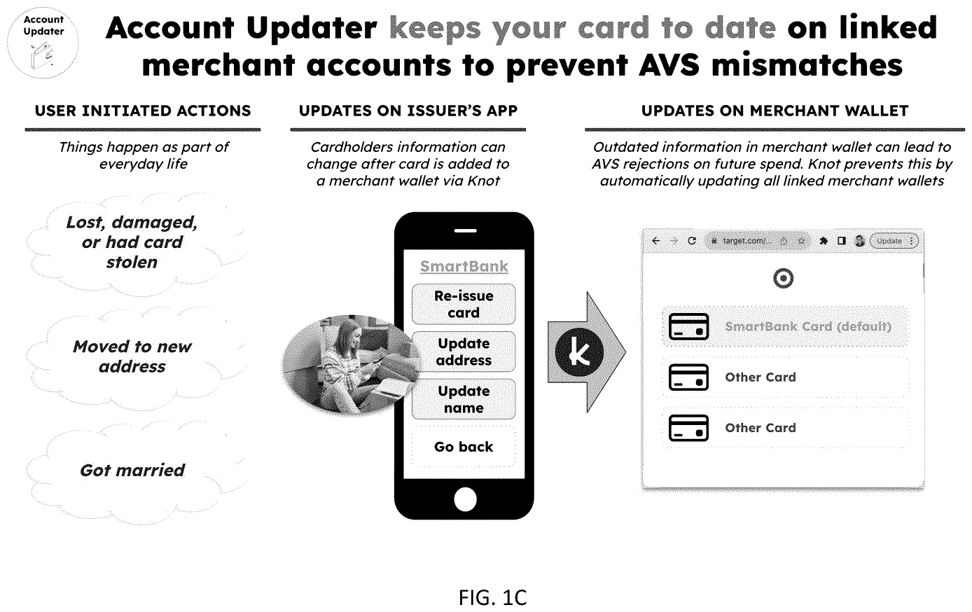

FIG. 1A shows an example of an architecture of a system 100 for implementing a payment account switcher, in accordance with some embodiments. A payment account switcher as described herein is capable of or configured to change or switch the default POF on a merchant or vendor system. In some embodiments, the system 100 includes an issuer system 110, a payment account switcher engine 120, and a plurality of merchant systems 131, 132, 133, 134, and 135 (collectively called merchant system 130). The payment account switcher engine 120 may communicate with a payment account switcher database 125 that may securely store data that is provided to the payment account switcher engine 120. The issuer system 110 may include a payment account switcher interface 115 that permits a user to interact with and provide inputs to change the default POF. The different components, systems, and subsystems within the system 100 may communicate with one another via any wired or wireless communications means.

The issuer system 110 may include any financial institution (e.g., bank, credit union) that can issue a card (e.g., credit card or debit card) or host/manage a consumer financial account (e.g., checking account, savings account, etc.). In some embodiments, the default POF includes a payment account that is saved on the account associated with the user on the merchant system and used to make purchases by the user. The issuer system 110 may include a banking environment whereby one or more cards may be issued for a user. Various payment account information may be viewable or accessible by the user in the issuer system 110 using a user interface such as a graphical user interface (GUI) that includes the payment account switcher interface 115. For example, the user may be able to view information related to recent transactions such as payee information, transaction amounts, transaction dates, etc. Further, various user information may be viewable and/or modified by the user using the user interface. For example, the user may modify any autopay options, modify the billing and/or mailing address for the payment account, etc.

While this disclosure generally discusses payment accounts and changing the default POF in the merchant system with respect to a card such as a credit card or a debit card for ease of description, embodiments are not limited thereto, and other types of payment methods may be used. For example, the default payment method on the merchant system may include a checking account or a savings account in a financial institution such as a bank or credit union, a cash account associated with a trading account, gift cards, a digital payments solution such as Venmo® or PayPal®, and others. Information that is relevant to the type of payment account may be used.

The issuer system 110 can be configured to perform or implement one or more methods for issuing a new credit card for the user. For example, the issuer system 110 can be configured to receive an application from the user for a new credit card, and the issuer system 110 can be configured to approve the user for the new credit card based at least in part on the user's credit history, credit score, etc. When the card is issued and available for use, the issuer system 110 can be configured to provide access to payment account information using the issuer system 110. The user may now use the new card on merchant systems 130 and use the payment account switcher described herein.

In some embodiments, the payment account switcher interface 115 may be dynamically generated and populated for the user. In some embodiments, the payment account switcher interface 115 may show one or more merchants that the user can connect to. In some embodiments, the user may use the payment account switcher interface 115 to select which merchants for which the user selects to switch the default POF on the respective merchant system 130.

The payment account switcher engine 120 may include one or more processors that are connected together to perform the steps of the process described herein. In some embodiments, the payment account switcher engine 120 may comprise a backend server or logic for the system 100. The payment account switcher engine 120 may be deployed in a cloud computing environment. The payment account switcher engine 120 may include an authorization module 122 and a switching module 124. The authorization module 122 may be configured to authorize a new user to the payment account switcher ecosystem and authorizing the user for the merchants that are enabled on the merchant systems 131-135.

The merchant system 130 may include any e-commerce business that accepts credit or debit card payments online. The e-commerce business may include online stores of retailers such as clothing or grocery stores, online or network service providers such as phone companies, Internet service providers, etc., home service providers such as pest control and cleaning services, etc., websites with paid subscriptions such as streaming services, news websites, etc., other financial institutions such as banks, brokerages, etc., and many others. The types of businesses that use the merchant system 130 is not limited to those described herein but can include any business with that can accept payment online is included. In this disclosure, any business that can accept online payment may be considered a merchant for ease of reference. Although five merchant systems 131-135 are shown, embodiments are not limited thereto, and fewer or more merchant systems may be connected to and accessible by the payment account switcher engine 120. In some embodiments, the merchant systems 130 may interface with the payment account switcher engine 120 via a website, a progressive web app, a mobile app, etc.

In some embodiments, data other than payment account information may be collected and/or stored from merchant systems and/or issuer systems including transaction information and profile information for various types of merchants and merchant systems. For example, the merchant system 130 may be for an e-commerce, ridesharing, food delivery, travel, streaming, gaming, etc. For example, for an e-commerce website, the data may pertain to product information for an e-commerce system, where the data may include seller information (e.g., name, URL of seller website), price of the product (e.g., discounted price, fees, fees per item), product ID, product name, product description, name of retailer and/or platform of listing, barcode information, shipment information such as how long shipment took, etc. In some embodiments, the data may pertain to rides that are ordered on a ridesharing system, where the data may include ride type, pick-up date and location, drop-off date and location, distance, vehicle information, driver information, price, etc. In some embodiments, the data may pertain to flight information for an airline system, where the data includes airline name, plane type, departure date and location, arrival date and location, seat number, seat type, any connecting flight information, etc. In some embodiments, the data may pertain to hotel or lodging reservation information for a hotel or lodging system, where the data includes hotel reservation information, hotel name, hotel brand, hotel location, room type, check-in date and time, check-out date and time, number of guests, contact information, etc. In some embodiments, the data may pertain to vehicle rentals for a vehicle rental system, where the data includes vehicle details (e.g., make, model, license plate, etc.), vehicle pick-up date and location, drop-off date and location, add-on services such as insurance, etc.

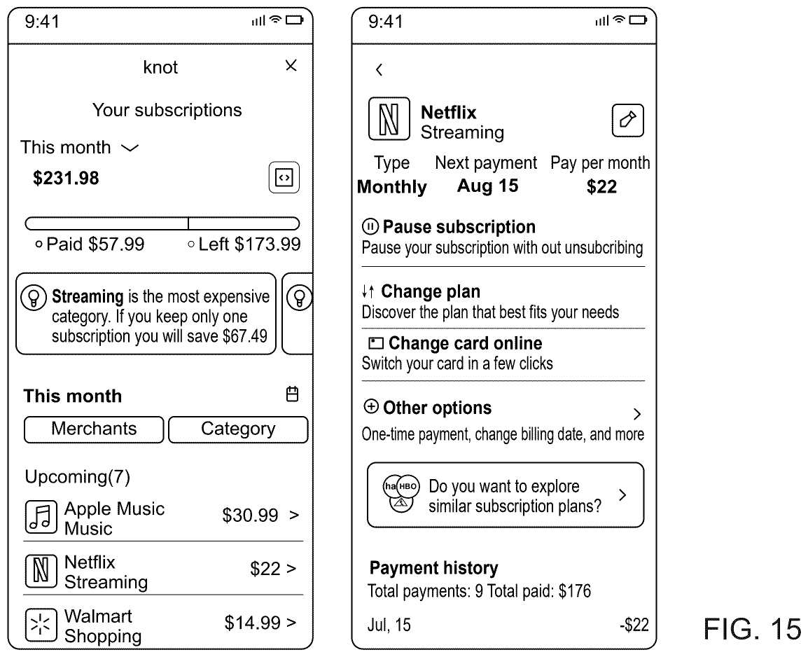

In some embodiments, the data may pertain to subscription services for a subscription system, where the data includes service provider name, URL, subscription tier, subscription start date, renewal date, price, etc. In some embodiments, payment information on various merchant systems may be tracked, including type of card, mobile payment service (e.g., Google Pay, Apple Pay), gift payment account information, merchant ID, brand information, billing address, price, taxes, fees, shipping, tips, miscellaneous charges, sub-total cost (before tax and tip), total cost, currency, date of transaction, merchant ID, shipping address, etc. The collected information may be stored in the payment account switcher database 125. As shown in FIG. 1B, the system 100 may comprise a subscription manager 123. Unlike conventional methods where subscription information is inferred through transactions, the subscription manager 123 of the system herein may retrieve subscription data directly from the merchant via direct API integration without relying on user transaction data to ensure 100% accuracy of the subscription information. In some cases, the subscription manager 123 may provide rich subscription data (e.g., tier, billing cycle, exp. date, payment method) through the direct API integration. The direct API integration also beneficially allows for instant subscription cancellation, update and other subscription management. As illustrated in FIG. 15, the subscription manager 123 may provide GUIs displaying subscription insights such as monthly recurring spend, calendar view, amount paid vs. remaining, future funds needs and the like. The subscription GUI may display categorized spend with spend organized by merchant and category, budget goals and alerts organized by category. The GUI may map all subscriptions by identifying subscriptions from internal spend, external (e.g., via Plaid), or manually added subscriptions with all popular merchants supported. The GUI may also allow users to manage or update their subscriptions via direct API integration (e.g., cancel or take a break, up/downgrade plans, make a one-time payment, change billing date, and the like). The GUI may allow users to change or update their card to external subscriptions on one tap. The GUI may further allow users to create a new account by identifying sign up offers and creating an account in one tap.

The subscription manager 123 may retrieve subscription data from merchants, process the subscription data to display insights on a GUI for a customer and allow the customer to manage their subscription as well as changing card for the subscription. In some cases, the subscription data may include, for example, name, tier name, status (e.g., active), billing cycle, price, descriptive details, start/expiration date, next renewal date, whether subscription can be canceled/upgraded/paid/free, type of payment method, or payment method. Such rich subscription data may be used by customer to manage subscription (e.g., cancel subscription, upgrade/downgrade/modify subscription plan). In some cases, the subscription data may also be provided to card issuer system or third-party for them to improve their products/marketing.

In some embodiments, profile information may include a snapshot of the user's account or profile on the merchant system, the user's searches and autocompletions of the searches, user history on the merchant system (e.g., watched items, read items, bought items, viewed items, etc.), user contact information, billing and security settings, notifications and reminders settings (e.g., subscribed channels, notifications for new movies or shows, etc.), user generated lists (e.g., watch lists, shopping lists, wish lists, etc.), current cart content, whether the user is associated with a larger organization (e.g., employee account of a company account), etc.

The payment account switcher engine 125 may be connected to and communicate with a payment account switcher database 125. The payment account switcher database 125 may store any and all data that is transferred through the payment account switcher engine 120. For example, the payment account switcher database 125 may include different types of data such as users'log-in credentials for merchants, credit payment account information, debit payment account information, and bank information. In some embodiments, the credentials may include cookies, headers related to authentication of the user session, session data, any other information that can be used to authenticate a user, etc. Credential and/or financial information may be tokenized, masked, or encrypted before being stored in the payment account switcher database 125. The data may include usage data such as whether the user is using a mobile device, such as a smartphone or a tablet, or a desktop computer. The data may include demographic data of the users such as age, sex/gender, marital status, household structure, income, wealth, education, geographic location, religion, and/or others. The data may include the different merchants with which each user has an account. The data may include the different merchants with which the user has showed interest.

The data collected and stored in the payment account switcher engine 125 may be used as a training dataset for training one or more machine learning algorithms. The machine learning algorithms may be used to predict, for example, the different merchants that a user of a certain demographic may use. Then the payment account switcher interface 115 may present the predicted list of merchants that the user can select to switch their default POF. As an example, the machine learning algorithm trained model may generate a list of merchants taking as input the user's geolocation, age, or other demographic information and output a personalized list of merchants that the user is likely to have accounts with. In some cases, the list of merchants may be ranked based on popularity of the merchants, relevance determined based at least in part on a characteristic of the user (e.g., age, geographic location, etc.). In some cases, performance of the model (e.g., prediction accuracy) may be improved by using the user's inputs as feedback to improve the model. For example, the difference between the model predicted list of merchants and the user's selected merchants may be used to further train the model.

In some embodiments, a machine learning algorithm may be trained to predict what type of user will utilize the payment account switcher. For example, depending on the demographic of the user, the machine learning algorithm may predict that certain people of a certain age would more likely use the payment account switcher than someone of a different age. Then, a bank or a financial institution that has a higher population of a certain demographic (e.g., more customers with a certain age range) may implement the payment account switcher into their issuer system 110.

In some embodiments, the payment account switcher engine 120 may include an authorization module 122 and a card switching module 124. The authorization module 122 may be used to authenticate the user's identity as described here. The card switching module 124 may be used to perform the operations for switching the default POF on the merchant system 130.

Although two modules are shown and described herein, the payment account switcher engine 120 may include more modules or each of the described modules may include sub-modules that perform various operations within the scope of this disclosure.

In some embodiments, the interconnection between the payment account switcher engine 120 (and the authorization module 122, switching module 124, monitoring module 126, and transaction link module 128, for example) may be automated to access the merchant systems. In some embodiments, the interconnection may replace the net stack of several different environments with a single easily modified and maintained one for consistency and stability. In some embodiments, the interconnection may normalize outgoing traffic making it indistinguishable from traffic from regular users (by deploying stealth and proxy routing). In some embodiments, the interconnection may centralize any egress to allow the payment account switcher engine 120 to monitor, store and analyze any and all outgoing traffic. In some embodiments, the interconnection may automatically strip sensitive information from said traffic when stored without compromising on the details that matter for debugging integrations.

### Initialization of a New User

In some embodiments, the method further comprises, prior to receiving the request to change the default POF, providing the user, via the issuer system, a payment account switcher interface to enter a set of information related to the account associated with the user. This information may be provided to the payment account switcher engine (e.g., the authorization module) to initialize a new user for the payment account switcher. Once an indication that a new user account is to be created, the payment account switcher engine may generate a new user account for the user.

In some embodiments, the method further comprises, prior to receiving the request to change the default POF, providing the issuer system a software development kit (SDK) to customize or create the payment account switcher interface that is shown to the user. In some embodiments, developers for the issuer system may use the SDK to initialize a card issuer interface that would be hosted on the issuer system and the issuer's application or webpage. In some embodiments, the SDK may include one or more commands that may enable the payment account switcher interface to work seamlessly with the payment account switcher engine.

In some embodiments, the method further comprises providing the user, via the payment account switcher interface, a list of merchants that the user can select. In some embodiments, the list of merchants is determined based at least in part on popularity of the merchants, relevance determined based at least in part on a characteristic of the user (e.g., age, geographic location, etc.), and/or a list prepared by the issuer system. In some embodiments, the user may provide a list of merchants that the user has an account for.

In some embodiments, the method further comprises, prior to receiving the request to change the default POF, receiving an indication that the user has the account with a merchant associated with the merchant system. In some embodiments, the method further comprises transmitting instructions to the issuer system to display an image, text, or other indication that the user has the account with the merchant.

### Authentication of a User

In some embodiments, one or more methods may be used to authenticate a user to access the merchant system. The authentication may be performed before the card switching is performed. A plurality of methods may be deployed by the authorization module 122 to authorize the user's identity for the merchant system. Although certain methods are described with respect to authorizing the users, embodiments are not limited thereto and the described methods may be modified within the scope of the disclosure.

In some embodiments, in each of the methods of authorization the user's identity, any received input (e.g., log-in information, credential information, other data) may be received and stored within the user's device, the issuer system, and/or the payment account switcher engine or database. In some embodiments, the input may be stored so that the payment account switcher engine may automatically log-in the user the next time the user wants to switch the default POF.

In some embodiments, the method may include receiving, from the user, credentials for authenticating the user's account on the merchant system. In some embodiments, after the user has selected the merchant, the user may input the user's credentials onto the payment account switcher interface 115. The user's credentials may be provided via a log-in ID and password combination, single sign-on (SSO), or face identification options. In some embodiments, a user agent can be used for enabling the SSO feature. Depending on embodiments, the user may also include multi-factor authentication (MFA) for logging into the merchant system for added security. In some embodiments, the method may include transmitting, to the merchant system, the credentials to authenticate the user's credentials.

### Authorizing for Mobile Device Using Merchant Webview

In some embodiments, when the user is using a mobile device or a computer, the method further comprises, prior to receiving the request to change the default POF, generating a merchant webview of a login page associated with the merchant. In some embodiments, the webview may include the merchant's web page that is shown directly within the payment account switcher interface, and the merchant webivew may be similar to or the same as the log-in page of the merchant's webpage that would be displayed on the web browser. In some embodiments, the merchant webview may be generated by the payment account switcher interface. In some embodiments, the merchant webview is a custom log-in page associated with the merchant. In some embodiments, the method may further comprise transmitting instructions to the issuer system to display the merchant webview to receive log-in information from the user. Afterward, the user may provide the user's credentials for the merchant system via one of several methods, e.g., merchant user ID/password, SSO, face ID, etc. In some embodiments, the issuer system 110 may communicate with the merchant system using one or more cookies, session tokens, etc. which can be serialized and transmitted via the payment account switcher engine 120.

In some embodiments, the method further comprises, after transmitting the instructions to display the merchant webview, monitoring the merchant webview for changes in cookies and/or uniform resource locators (URLs) to determine when the user is authenticated. In some embodiments, the payment account switcher engine may include instructions (e.g., via Javascript) into the webview to detect the log-in. In some embodiments, the method further comprises, during the monitoring, detecting that the user has successfully logged in to the account for the merchant. In some embodiments, the payment account switcher engine may detect that that the credentials provided by the user was successful in logging into the merchant system. After the authentication is completed, the payment account switcher engine may provide cookies, code headers, and other information from the webview to the database.

### Authorizing for Mobile Device Using Overlaid Log-in Page

In some embodiments, when the user is using a mobile device or a computer, the method comprises, prior to receiving the request to change the default POF, generating a merchant webview of a log-in page associated with the merchant, wherein the merchant webview is a custom log-in page associated with the merchant. In some embodiments, the method further comprises, after generating the merchant webview, transmitting instructions to the issuer system to: generate a log-in page or screen that is overlaid over the merchant webview. In some embodiments, the log-in page may include a custom log-in screen that is generated by the payment account switcher engine, and the payment account switcher engine may receive the information from the payment account switcher interface and communicate with the merchant system. In some embodiments, the merchant webpage may be running in the background (e.g., not presented to the user) and be in communication with the payment account switcher engine. Any credentials that is provided to the log-in page may be provided to the payment account switcher database to store the user credentials for future authorization.

In some embodiments, the method further comprises transmitting instructions to the issuer system to receive the credentials of the user via the log-in page, transfer the credentials to the merchant system via the merchant webview, and submit the credentials to the merchant system. In some embodiments, the merchant system may return a notification that the log-in attempt was successful if the user's credentials are valid. In some embodiments, the merchant system may return a notification that the log-in attempt was unsuccessful if the user's credentials are invalid. In some embodiments, when there is an error in logging into the merchant webpage using the credentials provided by the user, the payment account switcher engine may detect from the merchant webpage running in the background (via cookies, URL, webhooks, etc.) that the log-in attempt was not successful. In some embodiments, the user may be notified via the payment account switcher interface (e.g., on the login page) that the log-in attempt was unsuccessful.

In some embodiments, the method further comprises, after submitting the credentials to the merchant system, monitoring authentication of the credentials and providing any error messages, captchas, one-time password (OTP) requests, etc. to the user via the payment account switcher interface. In some embodiments, the method further comprises, after providing any error messages, captchas, OTP requests, etc. to the user, receiving a response from the user and transmitting the response to the merchant webview. Accordingly, if the merchant system has deployed additional security measures, the payment account switcher engine can provide the additional user input to the merchant system for a successful log-in.

### Authorizing for Computer Using Reverse Proxy

In some embodiments, when the user is using a desktop or laptop computer, authenticating the user's credentials comprises: using a hypertext transfer protocol (HTTP) reverse proxy that shows a merchant webpage to the user on a domain that is different from a merchant domain associated with the merchant; and providing one or more requests received from the user to the merchant domain based on one or more requests on the merchant webpage on the different domain. In some embodiments, the reverse proxy server may be included in the payment account switcher engine. In some embodiments, a reverse proxy server may be situation or disposed adjacent to the merchant webpage and can intercept incoming requests from the issuer system and/or the payment account switcher engine. The reverse proxy may provide the data and/or instructions to the merchant webpage, which can then return results to the reverse proxy that may be transmitted back to the issuer system and/or the payment account switcher engine. In some embodiments, the reverse proxy may have the look and feel of the merchant system's log-in page and be able to enable communication between the issuer system and the merchant system (via cookies, session tokens, etc.). In some embodiments, the reverse proxy may provide the information to the payment account switcher engine and provide any communicated information and/or data to the payment account switcher database.

In some embodiments, the domain on which the merchant webpage is shown may be a domain that is reserved by the payment account switcher engine. The domain reserved by the payment account switcher engine may also be referred to as “payment account switcher domain.” In some embodiments, even though the domain is different from the one being used by the merchant system, the merchant webpage shown may be the same or similar to the merchant webpage that would be displayed if on the domain of the merchant system. In some embodiments, any information that is provided to the merchant webpage on the payment account switcher domain may be provided to the merchant webpage on the merchant domain. And any responses by the merchant webpage on the merchant domain may be transferred and shown on the merchant webpage of the payment account switcher domain. In some embodiments, the system may monitor any changes in the cookies or URLs of the merchant webpage, or responses to authentication related endpoints on the merchant domain to determine whether the user's credentials were successfully or unsuccessfully authenticated by the merchant system.

In some embodiments, the method further comprises using an HTTP forward proxy between the issuer system and the merchant system to control data that is sent to the merchant system. In some embodiments, the payment account switcher engine may provide any data that is provided to the payment account switcher interface to the payment account switcher database. In some embodiments, the provided data may be useful for future updates to the payment account switcher engine and in improving the quality of the log-in experience for the user.

### Authorizing for Computer Using Remote Browser

In some embodiments, authenticating the user's credentials comprises, when the user is using a desktop or laptop computer: hosting a remote browser on a processor other than the desktop or laptop computer used by the user, wherein the remote browser has a URL set to a merchant webpage. In some embodiments, the remote browser may be run on a container in a virtual computer or server that is different from the device or computer that the user is using. In some embodiments, the user may provide the log-in information so that the merchant system may authenticate the user's identity. In some embodiments, the method further comprises streaming the merchant webpage to the desktop or laptop computer used by the user for authenticating the credentials. In some embodiments, the payment account switcher interface may show the user the merchant webpage via a window that shows the remote browser running on the virtual or remote server. Accordingly, even though the user is able to see a web browser with the merchant URL, the browser may be running on a virtual or remote server that is being hosted by a payment account switcher engine. Accordingly, the payment account switcher engine may monitor the data that is being provided by the user.

### Switching the Default Payment-Account-on-File

In some embodiments, the system 100 may be used to implement a computer-implemented method for changing a default POF for a user on a merchant system. The method may include receiving, from an issuer system (e.g., issuer system 110), a request to change the default POF on an account associated with the user on the merchant system (e.g., merchant system 130), wherein the issuer system is configured to manage a card that the user selects to use for the merchant system. In some embodiments, the request may be made via a payment account switcher interface (e.g., payment account switcher interface 115) that is presented to the user on a website or application of the issuer system. The payment account switcher interface may provide a list of merchants that the user may select. The user's selection may indicate that the user selects to change the default POF for the selected merchant.

In some embodiments, the methods described herein may be performed using application programming interface (API), webhooks, and/or other instructions via, e.g., Javascript. For example, one or more interactions among the issuer system, the payment account switcher interface, the payment account switcher engine, the payment account switcher database, and the merchant systems 130 may be performed using one or more programming instructions. In some embodiments, the webhooks are configured to monitor for one or more events including the user access or opening the merchant on the payment account switcher interface, authenticating the user credentials for the merchant system, updating the card on the merchant system, or completion of changing the default POF to the card. In some embodiments, the method may further comprise, during receiving the credentials, receiving from the user cookies, an access token, session data, JSON web tokens, etc. through the payment account switcher interface.

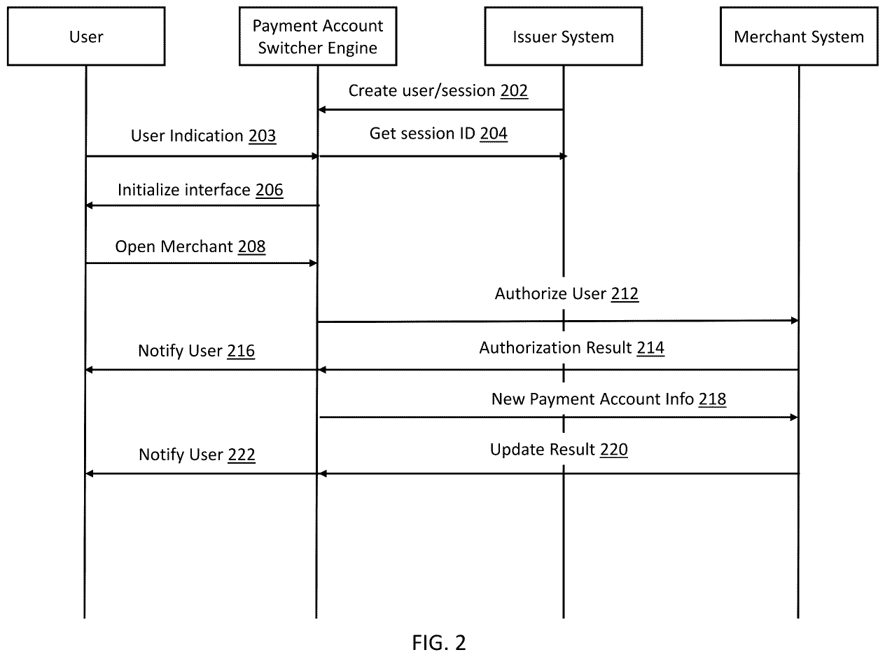

FIG. 2 shows a workflow diagram of the process of switching the default POF, in accordance with some embodiments. The workflow diagram shows the user, the payment account switcher engine, the issuer system, and the merchant system. Although certain entities and steps are shown, embodiments are not limited thereto, and additional entities and/or steps may be added or some entities and/or steps may be removed from the workflow diagram.

In some embodiments, the process may begin with the user being authenticated within the issuer system. In some embodiments, the user may log into the issuer system's application or webpage. In some embodiments, when the user logs in successfully to the issuer system, the user may be able to view the user's account(s) that the user has with that particular issuer. In some embodiments, the user may select a credit card or account.

In some embodiments, after the user has selected the credit card or account, the issuer system may create a user account or a session (202). In some embodiments, the issuer system may create a user account for the user if the user has not used the payment account switcher interface before. After the user account is created, the issuer system may create a session and a corresponding session ID for the session. In some embodiments, the session may include any instance when the user logs into the user's account on the issuer system's user interface. In some embodiments, if the user ID already exists (e.g., when the user has used the card switch before), the issuer system may create a new session and the corresponding session ID. After the user account (and user ID) and/or the session (and session ID) have been created, an indication may be sent to the payment account switcher engine that a new user account and/or a new session have been created. In some embodiments, the user ID and/or the session ID may be provided to payment account switcher engine.

The process may continue with a user indicating that the user selects to change the default POF by clicking on an option (e.g., a tile) on the user interface (203). Upon receipt of the user's indication by the payment account switcher engine, the payment account switcher engine request the session ID from the issuer system (204), if the payment account switcher engine does not already have the session ID. The session ID may be used to initialize the payment account switcher interface within the user interface of the issuer system (206).

After the user interface has been created, the user may identify or select one or more wallets and/or merchants on which wallet system or merchant system the user selects to change the default POF. After the user selects the one or more wallets or merchants, a merchant system log-in page may be opened and displayed (208). In some embodiments, the user may have previously provided the appropriate credentials to the payment account switcher engine which had been stored (e.g., in the payment account switcher database or the user's device). In this case, the log-in screen may not be shown or the user's credentials may already be prepopulated in the appropriate fields so that the user may click submit to submit their credentials.

The process may continue with the user's identity being authenticated with the merchant by providing those credentials to the merchant system (212). In some embodiments, the merchant system may authenticate the user's identity and provide a signal or a notification that the authorization has been successful to the payment account switcher engine (214). In some embodiments, if the provided credentials are incorrect, the merchant system may provide a signal or notification indicating that the credentials did not work. Once the payment account switcher engine receives the signal or notification, the user may be notified via the payment account switcher interface (216). In some embodiments, the receiving, from the merchant system, an indication that the user's credentials for the user's account have been authenticated for the merchant system. If the user's identity is authenticated, the process will continue with updating the default POF within the merchant system. However, if the user's identity is not authenticated, the user may be directed to the log-in screen for the merchant system again, and the user may be provided the option to enter the correct credentials, and the steps of 212-216 may be repeated until the user provides the correct credentials.

In some embodiments, the process may further comprise transmitting instructions to the merchant system to change the default POF for the user's account to the card that the user selects to use for the merchant system. In some embodiments, changing the default POF includes changing from a first card to a second card on the merchant system for future transactions made by the user. In some embodiments, transmitting instructions to the merchant system to change the default POF comprises transmitting an API call to the one or more endpoints associated with the merchant system to perform the change. In some embodiments, transmitting the API call comprises transmitting payment account information related to the payment account to the merchant system. In some embodiments, the payment account information includes a card number, an expiration date, and a verification code (e.g., CVV). In some embodiments, a billing zip code, a card holder's name, and other required information may be provided.

In some embodiments, the payment account information is contained within a token. In some embodiments, the account information may be tokenized before being transmitted to and from the issuer system. For example, the payment account information may be converted to a string of characters which may include a token. In some embodiments, the merchant system that receives the token may correlate the token with data within the payment account switcher engine and/or payment account switcher database.

The process may continue by automatically initiating the switching or updating the default POF (218). The payment account switcher engine may receive the user's payment account information from the issuer system, since the user has already authenticated their identity within the issuer system. In some embodiments, the issue system may provide, to the payment account switcher engine, account information including the card/account holder's name, card or account number, expiration date (if any), the card verification value (CVV) (if any), and/or billing address including zip code. The payment account switcher engine may then provide the information to the merchant system. The process may continue with the merchant system updating the default POF to the received new card or account. In some cases, the process may be initiated by a user logging into an account or a place that stores all passwords associated with a user, and once log in, the user may be allowed to switch the default POF on all or selected merchant accounts.

In some embodiments, changing or switching the default POF in the merchant system may be performed via one of a plurality of methods. For example, the payment account switcher engine can implement an API provided by the merchant system. In some embodiments, the payment account switcher engine may submit the payment account information directly to the merchant system via the API endpoints that are provided, maintained, and documented by the merchant system.

In some embodiments, transmitting instructions to the merchant system to change the default POF includes instantiating a web browser and simulating a direct interaction with the merchant client on the web browser. In some embodiments, switching the default POF may be performed by the payment account switcher engine by instantiating a browser and simulating a direct interaction with the merchant client. In some embodiments, the interaction may be performed via a user interface and browser automation tools to fill and submit forms on the merchant websites by querying the, e.g., HTML DOM and populating the form fields. In some embodiments, a form submission to submit the form fields may be triggered via a simulated mouse click.

In some embodiments, transmitting instructions to the merchant system to change the default POF includes monitoring data traffic to and from the merchant system and simulating manually changing the default POF. In some embodiments, switching the default POF may be performed emulating the manual steps that a user would perform to log into the merchant system. In some embodiments, the payment account switcher engine can simulate the traffic that the merchant system would have made while switching a card manually. In some embodiments, the payment account switcher engine may emulate the steps via API provided by the merchant system and automate user interactions with the merchant system. In some embodiments, the payment account switcher engine may perform this switching if, for example, switching via the API endpoints or the browser simulation is not available.

In some embodiments, the traffic can be simulated via a web browser as discussed above or an app client that is running the payment account switcher engine or at least connected to the engine. This method may differ from the original “browser method” in the way that in some embodiments, these browsers are served to the end user through a visual and interactive stream, offering real time feedback and control, and hosted in secure contexts and/or containers. An isolated (process separated) browser contexts and/or secure containers (OS/host isolation) that are hosted on isolated servers (separation from user network) may be deployed. This adds a security benefit as the containers/contexts are isolated from the user environment and network. In some embodiments, a remote browser can be a security benefit as it is isolated from the user environment and network, and requests to and from the merchant are only made through secure servers. In some embodiments, even though third party software may be used for orchestration of container deployment, some or all containers may be instantiated and orchestrated through the payment account switcher engine 120 and the images that run on them may be run by the payment account switcher engine 120 (and since they are open source there is no issue auditing them), and the hardware the orchestration software runs on may be performed by the organization that runs the payment account switcher engine 120. Furthermore, in some embodiments, customers may be served unique, secure and isolated containers, which are destroyed and never shared among other customers. Any point of vulnerability in security may need to go through multiple layers of virtualization and multiple hardware nodes. Accordingly, the browsers may be safe to use for the payment account switching.

In some embodiments, a distinction between using a web browser and an app client may lie in what is generating the request that gets sent over the network.

However, when the app method is used, a merchant may not be able to distinguish whether a browser or an app is accessing its system. In some embodiments, the payment account switcher engine may obtain and use the data for accessing a merchant system and generate requests that are sent to the merchant system, whereas the web browser method may include an intermediate layer of a browser that is actually the software in charge of making and transmitting these requests which may be fed the user information.

In some embodiments, a core difference may lie in how the traffic is synthesized in this case. Whether using a web browser or an app, data traffic may still be generated and transmitted. In some embodiments, a POST request containing JSON to an API endpoint using standard REST API can be used. However, in some embodiments, an RPC (remote procedure call like gRPC, Apache Thrift) can be used as well which may not be an HTTP request per se.

Furthermore, a POST with content type “application/x-www-form-urlencoded” can be sent which is how a browser would send the contents of a HTML form. However, that HTTP request is still a HTTP request, and can be generated by things other than a browser so long the content within it is encoded properly (e.g., url-encoded). Despite it still being a HTTP request though, this is likely not an API in the REST API sense but it's still traffic and thus can still be simulated. A similar method can be used for HTTP requests but with a content-type “multipart/form-data”.

In some embodiments, the payment account information may be securely stored in the payment account switcher database or a different secure vault hosted by a vault provider. In some embodiments, the vault provider may be responsible for storing the payment account information securely and forwarding the payment account information in a tokenized manner to the payment account switcher engine. In some embodiments, the payment account information may be transmitted from the issuer system to the payment account switcher engine and/or the merchant system via a JSON Web Encryption (JWE) encrypted payload.

In some embodiments, the merchant system may accept the payment account information directly. For example, the payment account information may get decrypted and sent directly to the merchant system, and no third party (e.g., payment processor) is party to the transaction.

In some embodiments, the merchant system may indirectly accept the payment account information, for example, via a payment processor. For example, the card instrument gets decrypted and sent to the payment processor of choice from the merchant system. Then, the payment processor may return a tokenized representation of the payment instrument which the merchant system expects to receive via the merchant APIs. In some embodiments, the payment account switcher engine may use the payment processor's APIs to provide the payment account information.

In some embodiments, the system may be used to update the user's payment account information in more than one merchant system at a time. For example, if the user has provided access to a plurality of user's merchant accounts, the system may be used to access and change all or a subset of all of the payment account information in the user's account in the merchant systems. The user may be provided the option to switch the payment account for all of the users'accounts or a list of accounts where the user can select to change.

After the default POF has been updated, a notification may be sent to the payment account switcher engine (220), and the user may be notified via the payment account switcher interface (222). In some embodiments, additional notifications may be sent to the user via email, text, phone call, mail, etc. Accordingly, the updated (or new) card that is now on file with the merchant system may be used to perform transactions with the merchant.

In some embodiments, the user may use the system to automatically update the user's payment account information on the merchant system. For example, if the user's credit card on file is stolen, damaged, or lost, the issuer system via the engine may provide any updated information such as a new card number, expiration date, CVV number, etc. to the merchant system so that the user may seamlessly continue to access the products or services provided by the merchant system. Furthermore, the system may automatically update any user information such as address changes or name changes.

In some embodiments, the system may be used as a card monitor for the merchant or the issuer by using, e.g., the monitoring module 126. For example, the monitoring module 126 may keep track of what cards are being used by users across the merchant system and provide insight to the merchant and/or the issuer. The issuer or merchant may be notified if there is a new card (that is not issued by the issuer) that is increasing in popularity over a certain time period or what the issuer's card is ranked in terms of how much the card is saved as the default POF. In some embodiments, the issuer may gain insight into which cards are being used for which merchants or which types of merchants (e.g., food delivery services, streaming services, online shopping websites, etc.). In some embodiments, the information may include competitive insights such as the most popular credit cards that are being used or what other issuers are the biggest threats.

Then the issuer may use this information to make changes to existing cards (e.g., provide better/different benefits) or issue a new card. In some embodiments, the issuer or merchant may be able to model behavior patterns in users and predict which cards will be used more than others. In some embodiments, the issuer or merchant may be notified when a card is no longer the default POF and then begin a campaign to “win back” the user to change back the default POF.

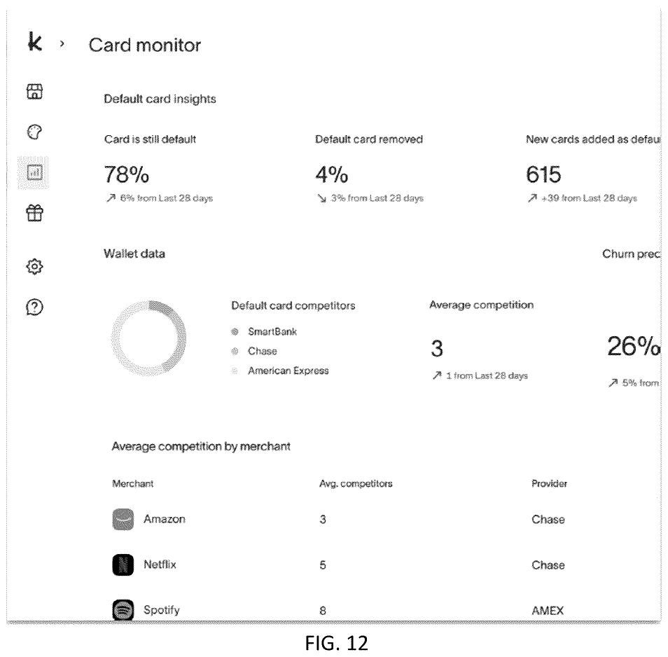

In some embodiments, a dashboard may be provided for the monitoring module 126 as shown in FIG. 12. For example, the dashboard may provide how many or what percentage of users are still using the issuer's card as the default POF as well as how much increase there has been over a period of time (e.g., how much change in percentage there has been in the last month). In some embodiments, the dashboard may also provide how many or what percentage of cards have been removed and what percentage change in removal there has been in a period of time (e.g., how much change in percentage there has been in the last month). In some embodiments, the dashboard may provide how many new cards have been added as the default POF over a period of time as well as how much change in percentage there has been in a period of time.

In some embodiments, the dashboard may provide competitive insight information. For example, the competitive insight information may include what percentage of default POFs are issued by which issuers. In some embodiments, the dashboard may also be able to provide recent trends, such as which card has gained popularity over a period of time or which card has fallen out of favor over a period of time.

In some embodiments, the dashboard may also provide competition by merchant information related to which cards are being used for which merchants. For example, the dashboard may show which cards are the most popular with which merchant.

In some embodiments, the dashboard may also provide information on the likelihood of the issuer's card being removed as the default POF. The likelihood may be determined based on analyzed trends, cards in the market, new cards being introduced, changed card benefits, etc. The issuers may use this information to change certain benefits of the cards they are issuing or begin campaigns to retain their customers.

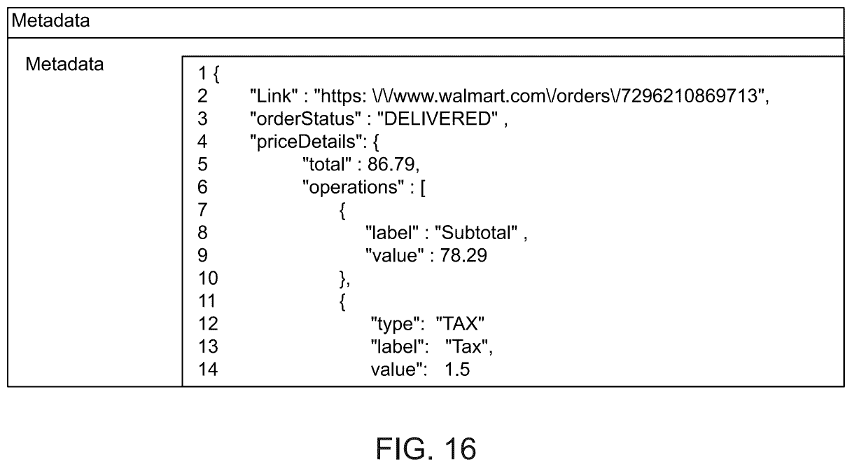

In some embodiments, the system may be able to provide information to the merchants using a transaction link module 128. The transaction link module 128 may provide insight to the merchant that the merchant can then use to retain and/or win back customers. For example, the merchant may be provided SKU-level information on transactions. The SKU-level information may include what items are being bought from which merchants at what price. The SKU-level information may also include buyer information such as age, sex, location, etc. FIG. 16 shows an example of SKU-level transaction data.

In some embodiments, users may be able to access transaction data using the transaction link module 128. For example, if the user bought an item at a merchant, and if the user has provided access to the user's account information for the merchant system to the payment account switch engine, the user may be able to view information related to all of the products and services they are paying for or subscribed to. In some embodiments, the transaction link module 128 may redirect the user to a direct website link including the transaction information. For example, the user may see a vague transaction description when the user logs into the issuer system for which the user's card was used to make the transaction. The transaction history may simply show vague information such as the merchant name and order number. Typically a user would have to log into the merchant system and look at the transaction history to find what item was purchased and correlate the transaction from the merchant system to the transaction in the issuer system. This can also be confusing because the transaction may not post immediately or take a few days to settle in the issuer system. However, in some embodiments, by using the, the user may be able to see exactly correlate the two transactions by clicking a link on the issuer system's transaction history or a similar interface on the issuer system (e.g., a link displaying a transaction in the transaction history on the payment account switcher interface 115). If the user has provided access to the engine to access the user's account in the merchant system, clicking the link can for example open up the order details of the exact transaction that was made in the user account.

As shown in FIG. 1B, the transaction link module 128 may provide item-level transaction data with an embedded approach to merchant account connectivity. Merchants, card issuers, and/or any other entities utilizing the transaction link (e.g., reward provider, etc.) may access the hyper-rich, item-level transaction data on the customers. The data link for the transaction data and other data in the Card Updater (account updater), Subscription Manager, Card Monitor, and Transaction Link may be provided via a persistent connection 150. The persistent connection 150 maintains a connection with the merchant after the initial authentication 151. A merchant or financial institutional may be provided option to turn off the persistent connection. FIG. 1C shows an example of account updater component. The account updater component may allow users to initiate an action such as upon lost, damaged or had card stolen, moving to a new address or any other change in the cardholder information (e.g., demographic information change). Upon detecting a change of the account (e.g., a user canceled/suspended a card, changed account holder information via an interface (UI) of a card issuer system), the account updater component may automatically update all the payment method associated with the account and/or the account information linked to the merchant systems. This beneficially allows for an automatic account update even after a payment method is added to a merchant system.

In some embodiments, the transaction data and/or the persistent connection in the transaction link module may be provided via the merchant's various API endpoints (e.g., pull/push connection depending on the merchant and endpoint). The transaction data may be retrieved on varying cadences and at the explicit request of the customer at a point in time. For example, the system or transaction link module makes a request to a given merchant's API with the API headers and request body required for that endpoint, receives large amounts of transaction data and parses the above information from the API responses. The data retrieval can be performed on a cadence and ad-hoc at the customer's request.

In some embodiments, the system or transaction link module may be capable of retrieving transaction data based on limited user information. For example, transaction data and/or rich transaction data can be retrieved based only on user name, phone number or email address. In some cases, the transaction link module may implement a method comprising i) detection process for efficiently detecting account existence (e.g., based on merchant response type and/or response time), ii) authentication process for seamlessly login and processing merchant responses, iii) establishing a secure session for further data retrieval. The method may be implemented via a security process to ensure the data exchange are encrypted and compliant with regulations.

A detection process may be utilized in the authentication, the transaction link and various other features of the system. The detection process may comprise: i) receiving limited user information (e.g., a customer phone number or email address) from a third-party (e.g., card issuer, etc), ii) initiating login attempt by logging in to the merchant's system using the provided information (e.g., email address along with a placeholder password), iii) parsing merchant response. If no user is found, the system may confirm that the account does not exist. If the password is incorrect, the system may confirm the account exists but requires valid credentials. Next, the system may implement an authentication process. The authentication process may comprise: i) initiating login with credentials (e.g., If the account exists, the transaction link module attempts to log in using client-provided credentials (phone/email and password)), ii) analyzing merchant responses. For example, if the password is correct, authentication is successful and the system may establish a secure session. If the password is incorrect, the system may prompt the customer for entering a correct password. In some cases, additional verification may be required (e.g., OTP, CAPTCHA) prior to establishing the session. If additional verification is required, the system man handling the additional verification by facilitating OTP workflows, CAPTCHA challenges, or other verifications, that may or may not involve the user interaction. Once authentication process is completed, the system establishes a secure session to interact with the user's account. The secure session may allow for further data retrieval and data exchange encrypted and compliant with regulations.

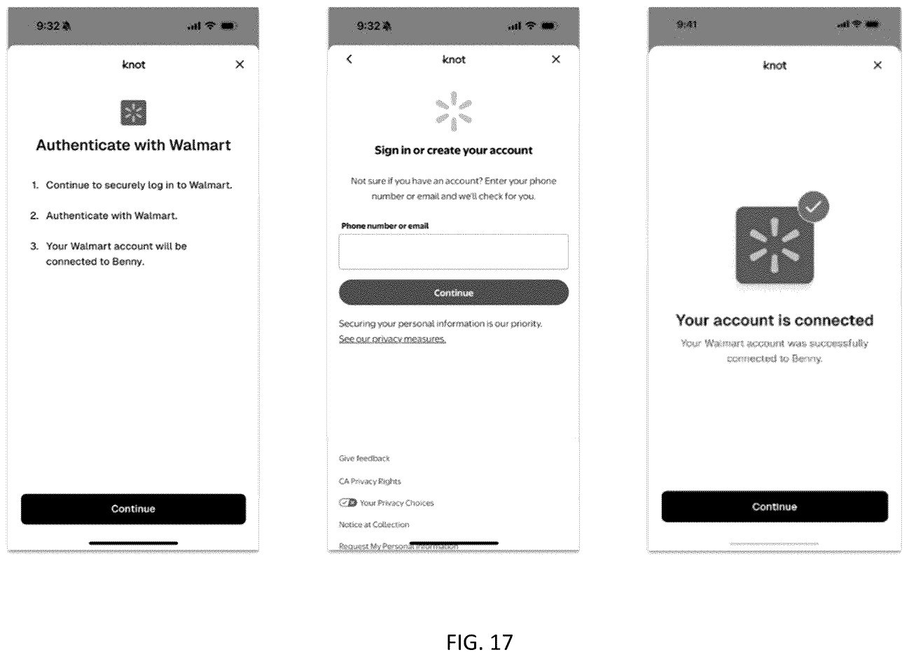

The transaction link module may allow users or merchant system/users (e.g., merchants, card issuers, any permitted third-party, etc.) to retrieve item/Stock Keeping Unit (SKU)-level purchase information for various use cases such as personal financial management, loyalty, expense management, fraud prevention, chargebacks, and targeted offers. FIG. 17 shows an example of webview or GUI of the transaction link module. The GUI may be provided to an individual user such as a consumer user. As described above, the initial sign-in or authentication may be used to maintain a persistent connection for retrieving the hyper-rich, item-level transaction data. In some instances, network session management techniques may be employed to ensure that the user (e.g., consumer) does not have to repeatedly authenticate within one session. For example, session cookies or tokens may be utilized to store user login information on the user device. The cookies or tokens may be securely communicated between the user device and a cloud instance or backend of the system to verify the user's identity, thereby maintaining a persistent authenticated state for the duration of the network session.

In some embodiments, a user may be provided offers from merchants that the user can then take advantage of by clicking on one link. For example, the user may be presented an offer in the interface 115 to create an account with a new merchant. If the user likes the offer and desires, the user may click the link, and then engine (e.g., account creator 125 in FIG. 1B) may automatically create an account with the merchant system and add a card in the issuer system as the default POF for the merchant. In some embodiments, the user may have provided information to the engine 120 or interface 115 beforehand to input the user's information for signing up on any new merchant websites. Accordingly, the user may be able to very easily and quickly take advantage of an offer by the merchant while the merchant gains a new user. The account creator 125 may be capable of automatically setting up merchant accounts for new users or cardholders, ensuring immediate usability.

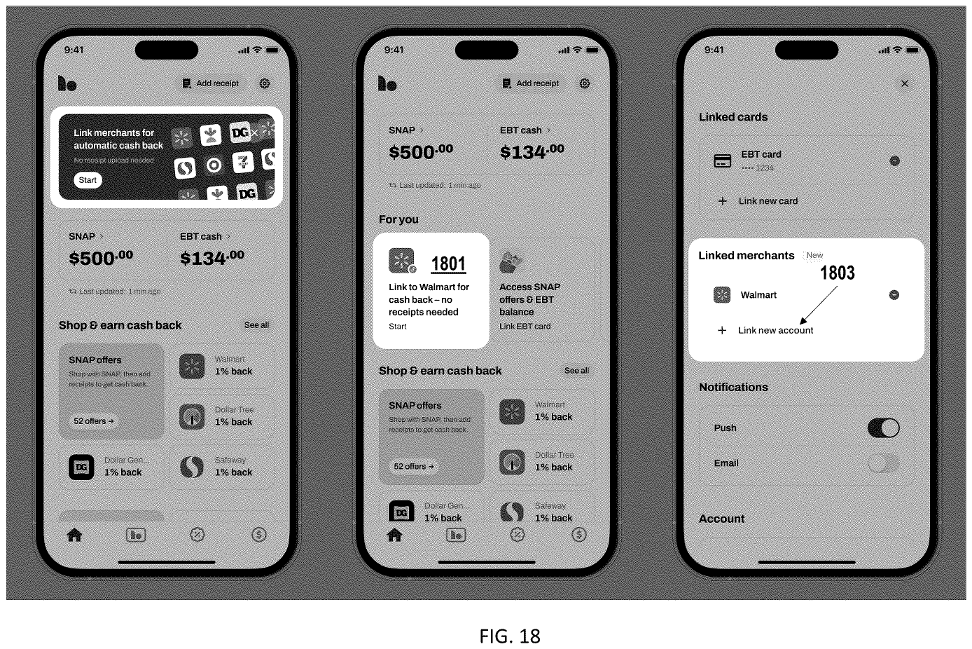

FIG. 18 shows another example of using transaction link module to automate user cashback rewards, ensuring faster processing and eliminating manual receipt uploads for users. Conventional rewards such as cash-back program may require customers to manually upload receipts to claim cash-back rewards, which a time-consuming process that can create friction and limited reward opportunities. The transaction link module herein beneficially provides a seamless solution that allows customers to earn cash-back rewards at eligible merchants without the hassle of manual uploads.

As shown in the example, a third-party system (e.g., cash-back rewards service system, retailer system, etc.) integrated with the transaction link module herein may improve the process of ingesting customer receipt data and, in turn, enhancing the cash-back rewards experience. With the transaction link module, the third-party system's customers can securely link their merchant accounts 1801, 1803, enabling the third-party system (e.g., cash-rewards system) to instantly access rich, reliable transaction data, including itemized purchase information for both online and in-store purchases as described above. By leveraging itemized transaction data the third-party system can automatically identify eligible purchases, ensuring customers receive cash back within a shortened period of time (e.g., 24 hours)-completely eliminating the need for manual receipt uploads. The transaction link integration provides the automated cash-back rewards by capturing every eligible purchase with improved accuracy and reliability.

### Agentic One-Click Shopping

In some embodiments, the system herein may act in an agentic manner to search and recommend items based on data retrieved from merchant systems. For example, the system herein may call the merchant's search API to pull back the products that the user is interested in buying. A user may be provided a chat-like user interface (UI) to explore products and make purchase. The system herein may leverage any existing AI agents, AI model, machine learning (ML) model or large language model (LLM) to extract the purchase intent and generate a list of product recommendations based on the user intent. The system may call the merchant system API for buy to complete the actual purchasing process. The user may be required to be authenticated into the merchant system for the system herein to seamlessly buy the product. This allows the user to complete the buying process within their own merchant account particularly when the merchant systems require a user to login (e.g., no guest checkout). In some embodiments, the transaction link module may allow for agentic one-click shopping/purchasing capability. The system herein may act in an agentic manner to search and recommend items based on the item-level transaction data provided by the transaction link module. For instance, a user may, via chat-like text-based interactions, to purchase product via a single click. A user may be provided a chat-like user interface (UI) to explore products and make purchase. The system herein may leverage any existing AI agents, AI model, machine learning (ML) model or large language model (LLM) to extract the purchase intent and generate a list of product recommendations based on the transaction data provided by the transaction link herein. An artificial intelligence (AI) agent can interact with its environment, collect data, and use the data to perform self-determined tasks to meet predetermined goals. An AI agent may comprise memory (“states”) and context management. AI agent's “state” refers to its current internal representation of the environment, including relevant information about its current situation, goals, and past interactions, essentially acting as the agent's “memory” that allows it to make informed decisions based on context. The state is typically stored in a structured format within the agent's memory system, which can include different levels such as short-term and long-term memory. Short-term memory stores temporary information needed for immediate decision-making, such as the last few user inputs in a conversation while long-term memory stores information that needs to be retained for a longer period, such as general knowledge or learned patterns. For example, AI agents may use context window to store a limited amount of recent conversation history, acting as a form of short-term memory. In some cases, the transaction data provided by the transaction link module herein may provide the long-term memory and the conversation history may provide the short-term memory.

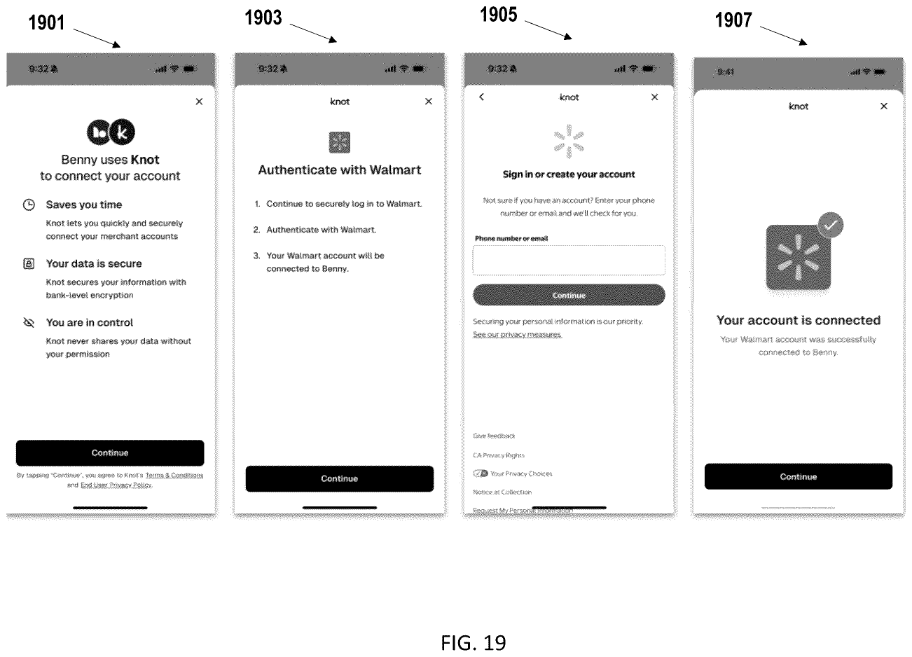

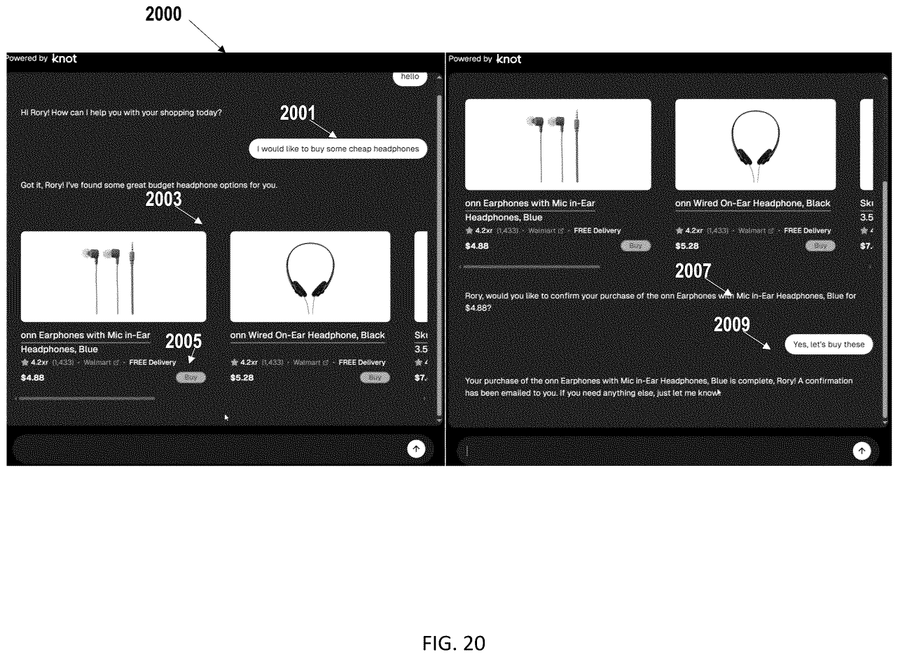

The one-click agentic shopping feature may comprise an intelligent product discovery with seamless transactional execution through direct API integrations. FIGS. 19-20 show an example of the one-click agentic shopping feature provided by the system herein. In the example, a user may submit, via a chat UI 2000, inquiries or requests 2001 (e.g., I would like to buy some cheap headphones). Upon receiving the user input, the system may employ the AI agent to query the merchant's search API to find, return, and display relevant products to users based on the user's input and preferences. The user preferences may be based on the transaction link data as described above. In some cases, the AI agent or the AI model may programmatically discover and query public (but undocumented) merchant search APIs to fetch relevant products 2003 based on user intent and preferences.

In some cases, the system herein may comprise an execution layer to generate inputs (e.g., structured prompt) for the agents or inputs for searching, selecting and executing the relevant merchant search APIs. For instance, these merchant APIs may not be scraped or reverse-engineered via browser sessions-they are legitimate, direct API endpoints. An undocumented merchant API may refer to an API (Application Programming Interface) provided by a merchant (e.g., Walmart, Amazon, Kroger) that is not publicly documented or has no formal developer documentation, SDKs, or onboarding process. The system herein may make server-to-server requests without browser emulation or scraping. This beneficially ensures direct, fast, and structured access to product data or user actions and avoid slow, brittle scraping or UI-based automation.

In some cases, as shown in the UI, the recommended products 2003 may be displayed with a one-click ‘buy’ option 2005. The system herein may display, for each recommended product, a one-click ‘buy’ option 2005 for a user to quickly and easily confirming the product to purchase. Once the user selects or affirms a product they'd like to purchase, the system may ask the user to confirm 2007 and the upon the user confirmation the selection of the product 2009, the user may be prompted to authenticate into their merchant account-if they haven't already done so, via the system login features as described elsewhere herein. For example, as shown in FIG. 19, the same secure authentication process as described elsewhere herein may prompt the user to connect to the merchant 1901, authenticate with the merchant 1903 such as via the merchant webview for login 1905 and successfully connect to the merchant account 1907. As described above, the authentication process is user-permissioned and managed entirely within the system SDK.

After authentication, the system may call the merchant's native “buy” API or checkout API to complete the purchase on behalf of the user. For instance, the system may supply the user default payment information, shipping address, contact information adapting to the merchant API parameters. The system may also add the payment method in the user authentication flow if needed. The system may make a direct API call to the merchant, instead of an emulated session or agent-based interaction. Without involving emulation or synthetic session, the direct API-based purchase beneficially ensures speed, reliability, and compliance The merchant system handles fulfillment, order confirmation, and payment directly, as they would in a standard user session. The system may then display the confirmation and details of the purchase to the user.

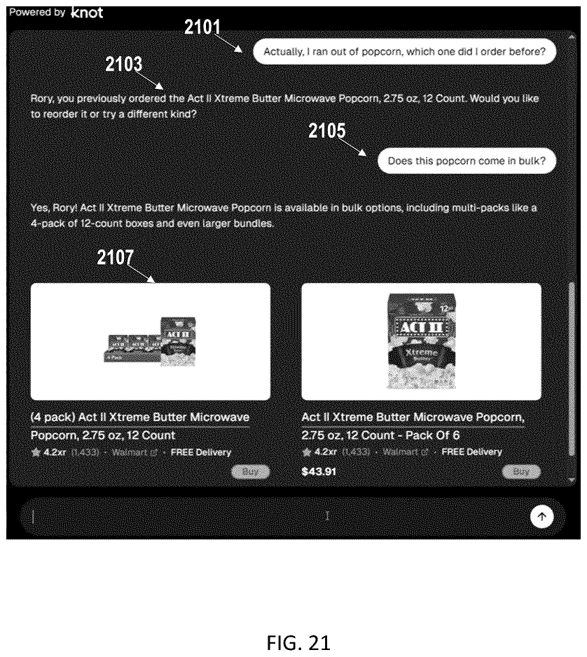

FIG. 21 shows another example of one-click agentic shopping. As shown in the example, a user input 2101 may indicate the intent to purchase a product that was purchased in the past but in different size 2105. The system may process the transaction link data and make the recommendation 2103, 2107 along with the one-click purchase button.

Another aspect is a computer system comprising a memory storing computer-readable instructions and at least one processor configured to execute the computer-readable instructions that are configured to perform the method of any of the aforementioned embodiments.

Another aspect is a non-transitory computer-readable storage media comprising executable instructions that, when executed by at least one processor, are configured to perform the method of any of the aforementioned embodiments.

### User Interfaces

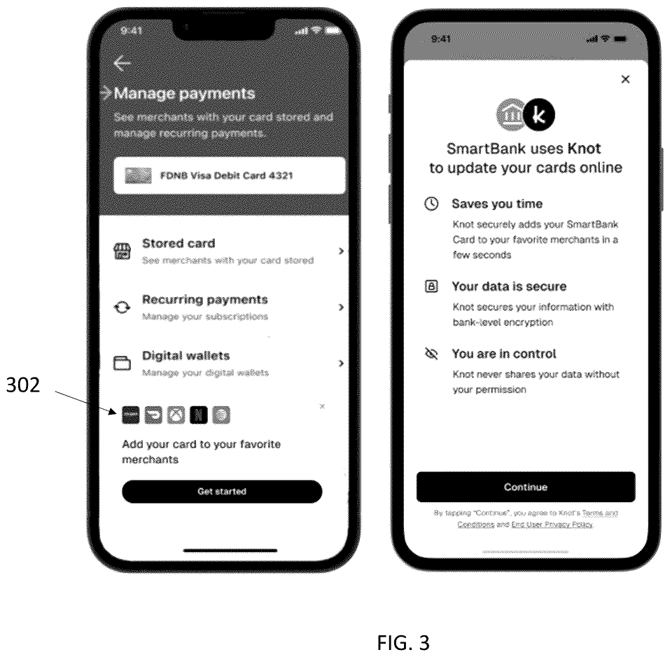

FIGS. 3, 4, 5, and 6 show example screenshots of a user interface of the payment account switcher (i.e., card switcher) interface on a mobile device, in accordance with some embodiments. As discussed elsewhere herein, the mobile device may include a smartphone, a tablet, a PDA, or any other electronic device that is not a computer. Although various example screenshots have been shown, embodiments are not limited to the example screenshots shown in FIGS. 3-6, and the user interface may vary depending on embodiments.

Referring to FIG. 3, a dashboard (or a home screen) of the user interface is shown, in accordance with some embodiments. In some embodiments, the user interface may be part of the user interface for a website or an app that is provided by the issuer system. In some embodiments, the dashboard may show the card (e.g., last four digits of the card number) or account number that the user is currently viewing. In some embodiments, the dashboard may include a tile 302 that the user may select, including a tile for the user to add a card to the wallets and merchants for quick and secure payments. In some embodiments, the dashboard may include a first screen for the payment account switcher interface. In some embodiments, the user may select the tile to begin the process of switching the default POF.

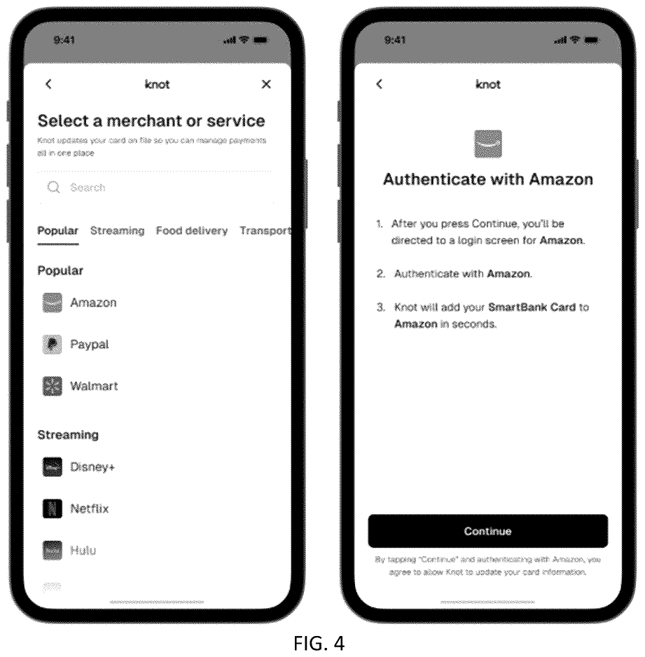

Referring to FIG. 4, a next screen is shown, in accordance with some embodiments. In a first workflow, after the user selects the tile to change the default POF, the user may be directed to a screen where the user has the ability to select which wallets or merchants that the user selects to change the default POF for. In some embodiments, only one of the list of wallets or the list of merchants may be shown. In some embodiments, the user may select one or more wallets including Apple Pay and PayPal, indicating that the user selects to use the selected card when making purchases with Apple Pay or PayPal. In some embodiments, the user may also select one or more merchants that have been prepopulated, including Netflix, Amazon, and Amazon Music, indicating that the user selects to use the selected card when making purchases or paying for subscription on any of the selected merchants. In some embodiments, the user may be displayed a merchant view of the login page discussed elsewhere herein.

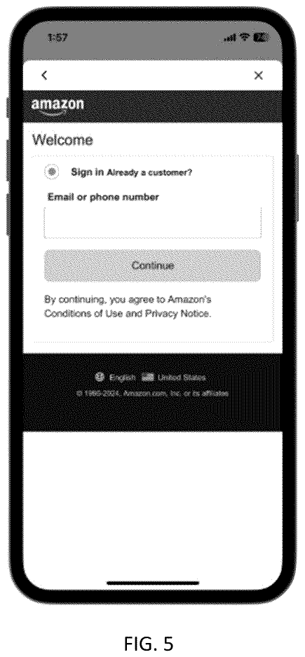

Referring to FIG. 5, a next screen is shown, in accordance with some embodiments. In some embodiments, once the user selects a wallet or merchant to change the default POF, the user may be shown a screen that asks the user for their log-in information, such as user ID and password. In some embodiments, the user may use SSO or Face ID, or any similar methods of logging into accounts.

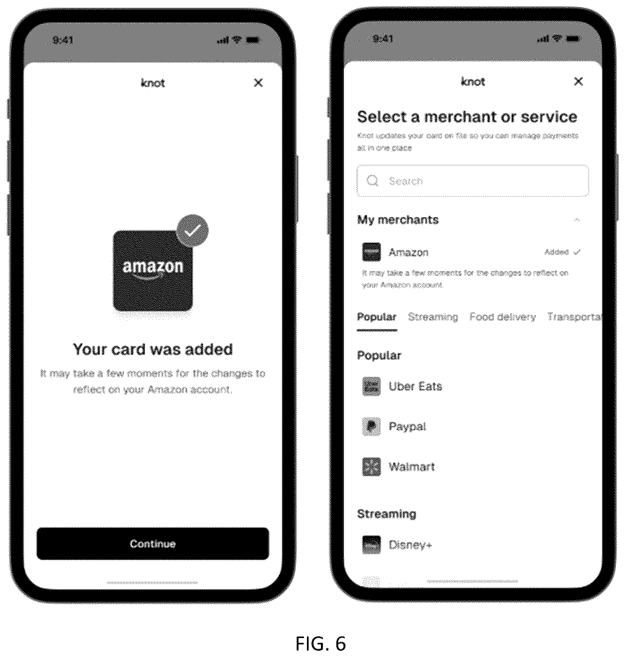

Referring to FIG. 6, a next screen is shown, in accordance with some embodiments. After the authentication process has been completed, the user may be shown a confirmation page that indicates that the default POF has been successfully switched to the selected card.

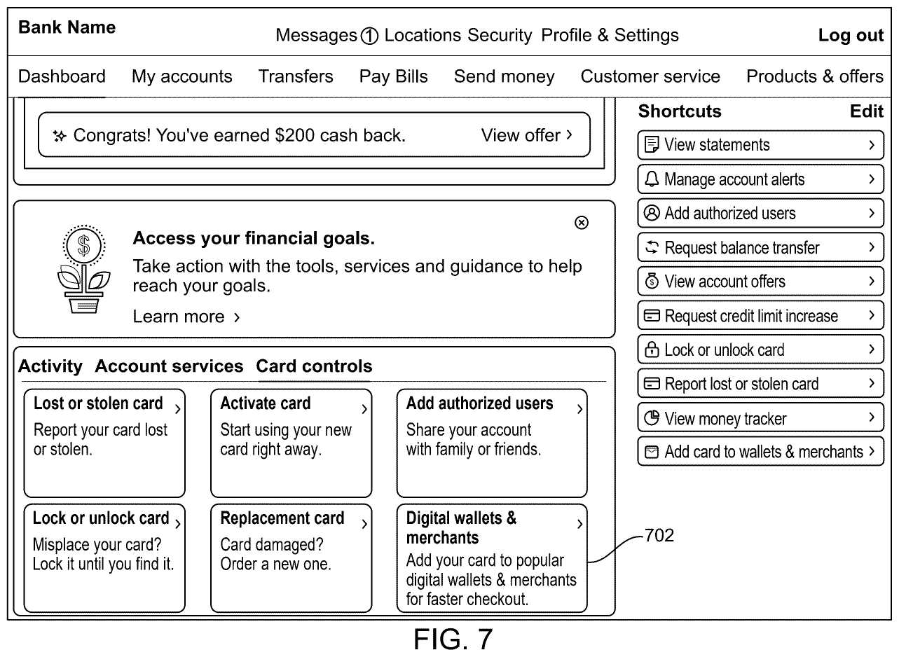

FIGS. 7, 8, 9, and 10 show examples of a user interface of the payment account switcher interface on a computer, in accordance with some embodiments. In some embodiments, the computer may include a desktop or laptop computer. Although various example screenshots have been shown, embodiments are not limited to the example screenshots shown in FIGS. 7-10, and the user interface may vary depending on embodiments.

Referring to FIG. 7, a dashboard (or a home screen) of the user interface is shown, in accordance with some embodiments. In some embodiments, the user interface may be part of the user interface for a website or an app that is provided by the issuer system. In some embodiments, the dashboard may show the card (e.g., last four digits of the card number) or account number that the user is currently viewing. In some embodiments, the dashboard may include a tile 702 that the user may select, including a tile for the user to add the selected card to the user's wallets and merchants for quick and secure payments. In some embodiments, the dashboard may include a first screen for the payment account switcher interface. In some embodiments, the user may select the tile to begin the process of switching the default POF.

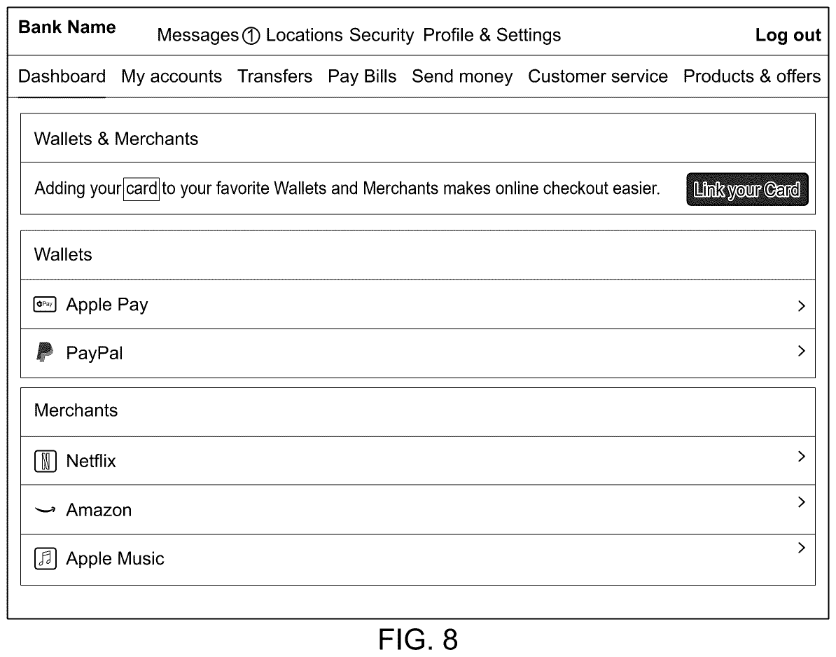

Referring to FIG. 8, a next screen is shown, in accordance with some embodiments. In a first workflow, after the user selects the tile to change the default POF, the user may be directed to a screen where the user has the ability to select which wallets or merchants that the user selects to change the default POF for. In some embodiments, only one of the list of wallets or the list of merchants may be shown. In some embodiments, the user may select one or more wallets including Apple Pay and PayPal, indicating that the user selects to use the selected card when making purchases with Apple Pay or PayPal. In some embodiments, the user may also select one or more merchants that have been prepopulated, including Netflix, Amazon, and Amazon Music, indicating that the user selects to use the selected card when making purchases or paying for subscription on any of the selected merchants.

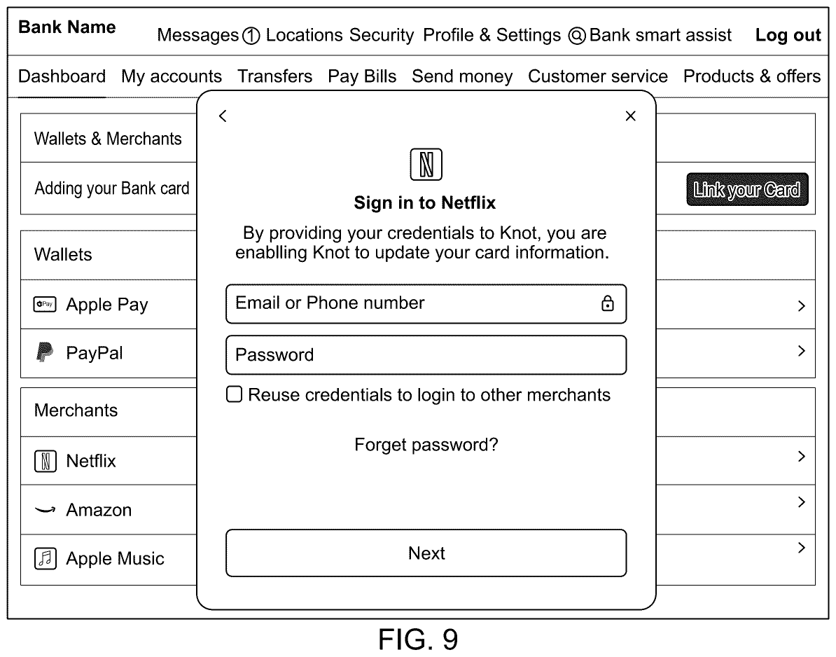

Referring to FIG. 9, a next screen is shown, in accordance with some embodiments. In some embodiments, once the user selects a wallet or merchant to change the default POF, the user may be shown a screen that asks the user for their log-in information, such as user ID and password. As shown in FIG. 9, the log-in screen may be overlaid over the background screen of FIG. 8. In some embodiments, the user may be displayed a merchant view of the login page discussed elsewhere herein. In some embodiments, the user may use SSO or Face ID, or any similar methods of logging into accounts.

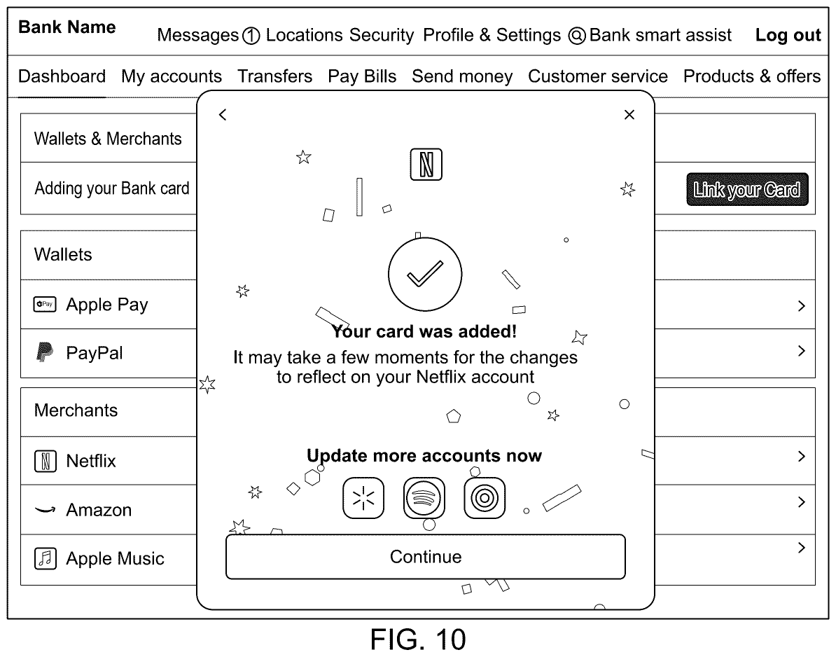

Referring to FIG. 10, a next screen is shown, in accordance with some embodiments. After the authentication process has been completed, the user may be shown a confirmation page that indicates that the default POF has been successfully switched to the selected card.

### Mass Switcher

As described above, the payment account switcher interface may provide a list of merchants that are commonly used to the consumer so that the consumer can select which merchants they want to switch the POF. The user may choose a merchant from the list and the user can log-in to their selected merchants by providing log-in information which may be kept secure. As described above, the log-in page may be a page generated by the system herein and appear to be similar to the log-in page of the merchant. In some cases, the system may generate the log-in page with modified visual elements. For example, the log-in page may display instruction or indication that the user is providing the credential to the system, or display the merchant icon while removing unnecessary information to not confuse the user.

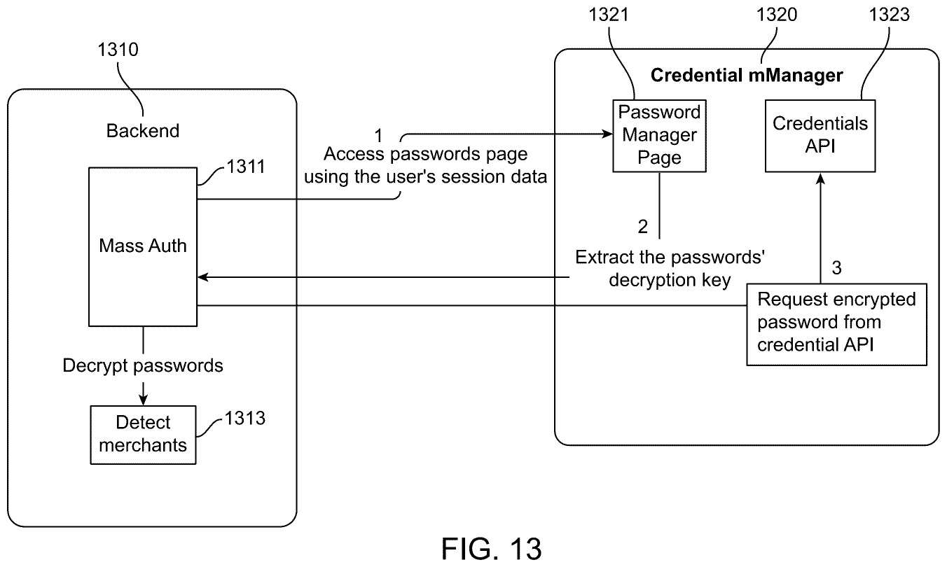

In some embodiments, the system herein may further provide mass switcher feature that a user may choose a plurality of merchants to change the default POF without entering the credentials for each merchant manually. FIG. 13 shows the mass switching component implemented in the backend 1310 in communication with a credential management system 1320 for the mass switching feature. In alternative cases, mass switch may be performed without exchanging passwords (e.g., browser extension-based).

The credential management system 1320 may be a credential keychain, a single sign-on (SSO) account or any other credential managers (e.g., browser extension, API, etc.) that stores all the usernames, passwords associated with a user or allows a user to access different accounts, websites by a single set of credential. As shown in the example, the credential management system 1320 may comprise a password manager page 1321 and a credential API 1323. For instance, a browser extension utilizes the Credential Management API to allow websites to securely store and retrieve user login credentials such as usernames and passwords.

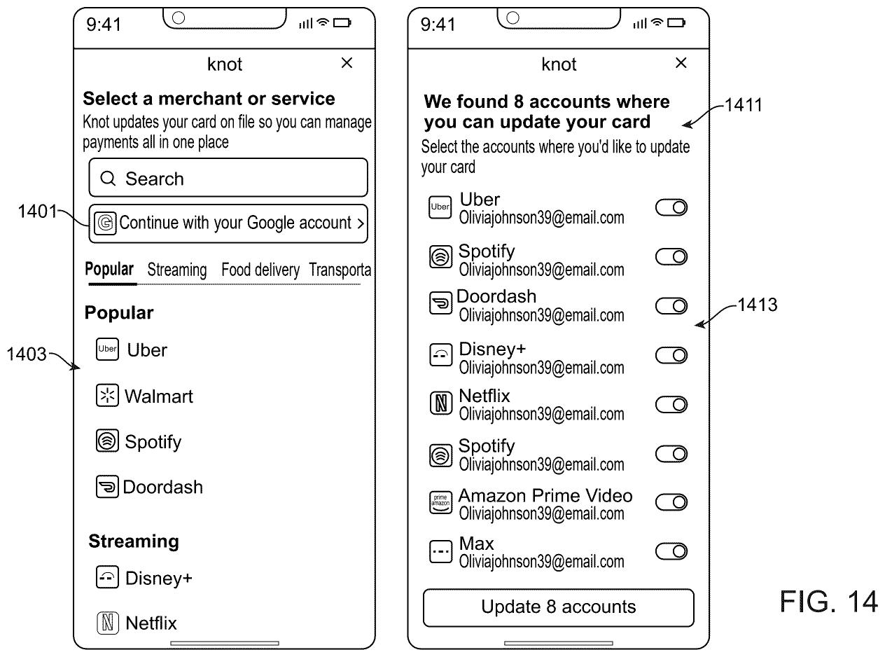

In some embodiments, the mass switching component in the backend 1310 may comprise a mass authentication module 1311 and a module 1313 for detecting merchants. In an example of process of mass switching, a user may first log in to a credential management account (e.g., passwords. google. com) through a web-view provided by the backend system or the SDK as described elsewhere herein (e.g., system 100). For example, the user may be prompted to manually input a password to log into a credential management account provided by the credential manager 1320 via a web-view generated by the backend 1310. FIG. 14 shows an example of a web-view displaying an option for a user to log into a credential management account or a SSO account 1401. In some cases, the web-view may also display a list of personalized merchants that the user may choose to switch the POF as described above.

Referring back to FIG. 13, upon receiving the credential to log into the credential management account, the mass authentication component 1311 may access the password page 1321 using the session data. If the login is successful, the SDK 1321 sends the user's account cookies (e.g., Google cookies) and final redirect URL to backend system 1310. The backend system or the mass authentication component 1311 may proceed to access the URL (e.g., passwords. google. com) to extract the passwords'decryption key. Next, the backend system may request encrypted password from the credential API 1323. The mass authentication component may extract and decrypt the (encrypted) passwords using the decryption key. The component for detecting merchants 1313 may then process the decrypted passwords and associated merchants accounts to extract the merchants (i.e., identified or detected merchants).

Upon extracting the merchants, as shown in FIG. 14, a web-view provided by the backend system may be updated or modified to display the detected or identified merchants accounts 1411 along with a list of the detected merchants 1413 with options for the user to select to switch the POF. For example, the user may toggle to select/de-select the merchants accounts for the mass switch of the POF. In some cases, after submitting the credentials to the selected merchant systems, the method may comprise monitoring authentication of the credentials and providing any error messages, captchas, one-time password (OTP) requests, etc. to the user as described elsewhere herein.

Such mass switching feature beneficially allows users to login to a SSO or credential management account and subsequently switch the POF across multiple merchants in a seamless manner using the store credentials in the SSO. As described above, upon a single loin to the SSO account, the system herein may automatically extract merchants for which the users have credentials stored thereon.

### Machine Learning

As used herein, the terms “artificial intelligence,” “artificial intelligence techniques”, “artificial intelligence operation,” and “artificial intelligence algorithm” generally refer to any system or computational procedure that may take one or more actions to enhance or maximize a chance of achieving a goal. The term “artificial intelligence” may include “generative modeling,” “machine learning” (ML), or “reinforcement learning” (RL).

As used herein, the terms “machine learning,” “machine learning techniques,” “machine learning operation,” and “machine learning model” generally refer to any system or analytical or statistical procedure that may progressively improve computer performance of a task. In some cases, machine learning may generally involve identifying and recognizing patterns in existing data in order to facilitate making predictions for subsequent data. Machine learning may include a machine learning model (which may include, for example, a machine learning algorithm).

Machine learning, whether analytical or statistical in nature, may provide deductive or abductive inference based on real or simulated data. The machine learning model may be a trained model. Machine learning (ML) may comprise one or more supervised, semi-supervised, self-supervised, or unsupervised machine learning techniques. For example, an ML model may be a trained model that is trained through supervised learning (e.g., various parameters are determined as weights or scaling factors). ML may comprise one or more of regression analysis, regularization, classification, dimensionality reduction, ensemble learning, meta learning, association rule learning, cluster analysis, anomaly detection, deep learning, or ultra-deep learning. ML may comprise, but is not limited to: k-means, k-means clustering, k-nearest neighbors, learning vector quantization, linear regression, non-linear regression, least squares regression, partial least squares regression, logistic regression, stepwise regression, multivariate adaptive regression splines, ridge regression, principal component regression, least absolute shrinkage and selection operation, least angle regression, canonical correlation analysis, factor analysis, independent component analysis, linear discriminant analysis, multidimensional scaling, non-negative matrix factorization, principal components analysis, principal coordinates analysis, projection pursuit, Sammon mapping, t-distributed stochastic neighbor embedding, AdaBoosting, boosting, gradient boosting, bootstrap aggregation, ensemble averaging, decision trees, conditional decision trees, boosted decision trees, gradient boosted decision trees, random forests, stacked generalization, Bayesian networks, Bayesian belief networks, naïve Bayes, Gaussian naïve Bayes, multinomial naïve Bayes, hidden Markov models, hierarchical hidden Markov models, support vector machines, encoders, decoders, auto-encoders, stacked auto-encoders, perceptrons, multi-layer perceptrons, artificial neural networks, feedforward neural networks, convolutional neural networks, recurrent neural networks, long short-term memory, deep belief networks, deep Boltzmann machines, deep convolutional neural networks, deep recurrent neural networks, or generative adversarial networks.

Training the machine learning model may include, in some cases, selecting one or more untrained data models to train using a training data set. The selected untrained data models may include any type of untrained machine learning models for supervised, semi-supervised, self-supervised, or unsupervised machine learning. The selected untrained data models be specified based upon input (e.g., user input) specifying relevant parameters to use as predicted variables or other variables to use as potential explanatory variables. For example, the selected untrained data models may be specified to generate an output (e.g., a prediction) based upon the input.

Conditions for training the machine learning model from the selected untrained data models may likewise be selected, such as limits on the machine learning model complexity or limits on the machine learning model refinement past a certain point. The machine learning model may be trained (e.g., via a computer system such as a server) using the training data set. In some cases, a first subset of the training data set may be selected to train the machine learning model. The selected untrained data models may then be trained on the first subset of training data set using appropriate machine learning techniques, based upon the type of machine learning model selected and any conditions specified for training the machine learning model. In some cases, due to the processing power requirements of training the machine learning model, the selected untrained data models may be trained using additional computing resources (e.g., cloud computing resources). Such training may continue, in some cases, until at least one aspect of the machine learning model is validated and meets selection criteria to be used as a predictive model.

In some cases, one or more aspects of the machine learning model may be validated using a second subset of the training data set (e.g., distinct from the first subset of the training data set) to determine accuracy and robustness of the machine learning model. Such validation may include applying the machine learning model to the second subset of the training data set to make predictions derived from the second subset of the training data. The machine learning model may then be evaluated to determine whether performance is sufficient based upon the derived predictions. The sufficiency criteria applied to the machine learning model may vary depending upon the size of the training data set available for training, the performance of previous iterations of trained models, or user-specified performance requirements. If the machine learning model does not achieve sufficient performance, additional training may be performed. Additional training may include refinement of the machine learning model or retraining on a different first subset of the training dataset, after which the new machine learning model may again be validated and assessed. When the machine learning model has achieved sufficient performance, in some cases, the machine learning may be stored for present or future use. The machine learning model may be stored as sets of parameter values or weights for analysis of further input (e.g., further relevant parameters to use as further predicted variables, further explanatory variables, further user interaction data, etc.), which may also include analysis logic or indications of model validity in some instances. In some cases, a plurality of machine learning models may be stored for generating predictions under different sets of input data conditions. In some embodiments, the machine learning model may be stored in a database (e.g., associated with server). As an example of training a model for generating the list of merchants that are commonly used to the consumer so that the consumer can select which merchants they want to switch the POF, a dataset (e.g., purchase data, category labels, merchants, etc.) may be tokenized to match the model, then backpropagation is used to compute gradients of a loss function (e.g., CrossEntropyLoss) with respect to the model's parameters, and then update the parameters to reduce the loss. In some cases, algorithms such as gradient checkpointing and mixed precision training (e.g., fp16/bf16) may be employed to manage memory usage. In some cases, the method may employe Low-Rank Adaptation (LoRA) and PEFT (Parameter Efficient Fine-Tuning) methods to backpropagate through fewer parameters.

In some embodiments, the machine learning may be based on a large language model (LLM). An LLM is a type of AI model designed to understand generate human language. These models are built using deep learning techniques, such as transformers, which enable them to capture complex language patterns and relationships. LLMs are trained on massive amounts of text data, such as books, articles, websites, and more, to learn grammar, syntax, semantics, and even some level of common-sense reasoning. They can generate coherent and contextually relevant text, making them highly versatile for a wide range of language processing tasks.

### (a) Computer Systems

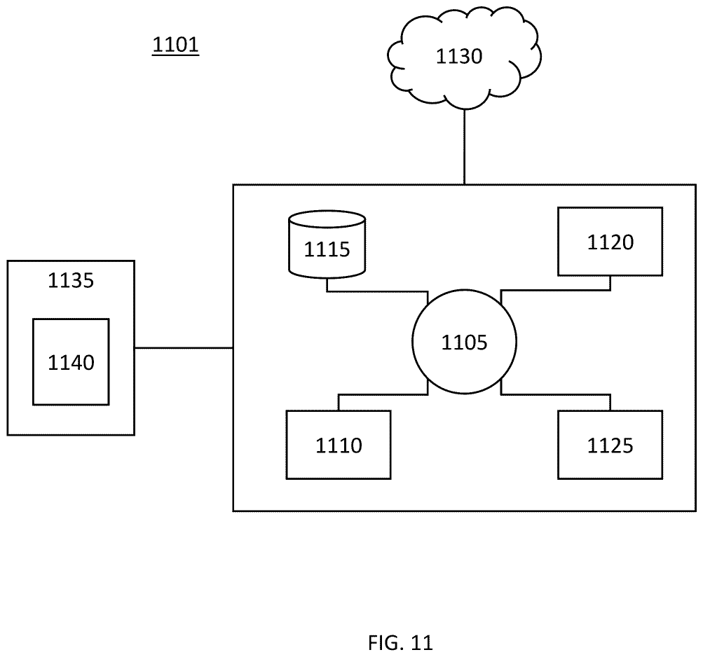

The present disclosure provides computer systems that are programmed to implement methods of the disclosure. FIG. 11 shows a computer system that is programmed or otherwise configured to enable a user to switch the default POF at a merchant system. The computer system 1101 can regulate various aspects of the present disclosure, for example, for communications and logic among the issuer system, the payment account switcher engine, and/or the merchant system. The computer system 1101 can be an electronic device of a user or a computer system that is remotely located with respect to the electronic device.

The computer system 1101 includes a central processing unit (CPU, also “processor” and “computer processor” herein) 1105, which can be a single core or multi core processor, or a plurality of processors for parallel processing. The computer system 1101 also includes memory or memory location 1110 (e.g., random-access memory, read-only memory, flash memory), electronic storage unit 1115 (e.g., hard disk), communication interface 1120 (e.g., network adapter) for communicating with one or more other systems, and peripheral devices 1125, such as cache, other memory, data storage and/or electronic display adapters. The memory 1110, storage unit 1115, interface 1120 and peripheral devices 1125 are in communication with the CPU 1105 through a communication bus (solid lines), such as a motherboard. The storage unit 1115 can be a data storage unit (or data repository) for storing data. The computer system 1101 can be operatively coupled to a computer network (“network”) 1130 with the aid of the communication interface 1120. The network 1130 can be the Internet, an internet and/or extranet, or an intranet and/or extranet that is in communication with the Internet. The network 1130 in some cases is a telecommunication and/or data network. The network 1130 can include one or more computer servers, which can enable distributed computing, such as cloud computing. The network 1130, in some cases with the aid of the computer system 1101, can implement a peer-to-peer network, which may enable devices coupled to the computer system 1101 to behave as a client or a server.

The CPU 1105 can execute a sequence of machine-readable instructions, which can be embodied in a program or software. The instructions may be stored in a memory location, such as the memory 1110. The instructions can be directed to the CPU 1105, which can subsequently program or otherwise configure the CPU 1105 to implement methods of the present disclosure. Examples of operations performed by the CPU 1105 can include fetch, decode, execute, and writeback.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit 1115 can store user data, e.g., user preferences and user programs. The computer system 1101 in some cases can include one or more additional data storage units that are external to the computer system 1101, such as located on a remote server that is in communication with the computer system 1101 through an intranet or the Internet.

The computer system 1101 can communicate with one or more remote computer systems through the network 1130. For instance, the computer system 1101 can communicate with a remote computer system of a user (e.g., a mobile device). Examples of remote computer systems include personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants. The user can access the computer system 1101 via the network 1130.

Methods as described herein can be implemented by way of machine (e.g., computer processor) executable code stored on an electronic storage location of the computer system 1101, such as, for example, on the memory 1110 or electronic storage unit 1115. The machine executable or machine readable code can be provided in the form of software. During use, the code can be executed by the processor 1105. In some embodiments, the code can be retrieved from the storage unit 1115 and stored on the memory 1110 for ready access by the processor 1105. In some embodiments, the electronic storage unit 1115 can be precluded, and machine-executable instructions are stored on memory 1110.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1101 can include or be in communication with an electronic display 1135 that comprises a user interface (UI) 1140 for providing, for example, a dashboard. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1105.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft SQL Server, mySQL, and Oracle. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash ActionScript, JavaScript, or Silverlight. In some embodiments, a web application is written to some extent in a server-side coding language such as Active Server Pages (ASP), ColdFusion, Perl, Java, JavaServer Pages (JSP), Hypertext Preprocessor (PHP), Python, Ruby, Tcl, Smalltalk, WebDNA, or Groovy. In some embodiments, a web application is written to some extent in a database query language such as Structured Query Language (SQL). In some embodiments, a web application integrates enterprise server products such as IBM Lotus Domino. In some embodiments, a web application includes a media player element. In various further embodiments, a media player element utilizes one or more of many suitable multimedia technologies including, by way of non-limiting examples, Adobe Flash, HTML 5, Apple QuickTime, Microsoft Silverlight, Java, and Unity.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java, JavaScript, Pascal, Object Pascal, Python, Ruby, VB.NET, WML, and XHTML/HTML with or without CSS, or combinations thereof.

Suitable mobile application development environments are available from several sources. Commercially available development environments include, by way of non-limiting examples, Airplay SDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java, Lisp, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, image, cell state, protocol, and culture condition information. In various embodiments, suitable databases include, by way of non-limiting examples, relational databases, non-relational databases, object-oriented databases, object databases, entity-relationship model databases, associative databases, XML databases, document-oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based at least in part on one or more local computer storage devices.

While preferred embodiments of the present disclosure have been shown and described herein, it will be obvious to those skilled in the art that such embodiments are provided by way of example only. It is not intended that the present disclosure be limited by the specific examples provided within the specification. While the embodiments of the present disclosure have been described with reference to the aforementioned specification, the descriptions and illustrations of the embodiments herein are not meant to be construed in a limiting sense. Numerous variations, changes, and substitutions will now occur to those skilled in the art without departing from the embodiments of the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the embodiments of the present disclosure. It is therefore contemplated that the present disclosure shall also cover any such alternatives, modifications, variations or equivalents. It is intended that the following claims define the scope of the invention(s) and that methods and structures within the scope of these claims and their equivalents be covered thereby.

1. A computer-implemented method for managing and updating a default payment-account-on-file (POF) for a user on a merchant system, comprising:
(a) generating, by a backend system, a list of merchant systems based at least in part on user profile data associated with the user and displaying within a graphical user interface (GUI), the list of merchant systems, wherein the GUI is provided by the backend system;
(b) displaying, within the GUI provided by the backend system, a web-view prompting the user to log into a credential management account in a network session, wherein the credential management account is provided by a credential management system that is not part of the backend system;
(c) accessing the credential management account using session data associated with the network session to log into the credential management account;
(d) receiving, by the backend system, authentication cookies or tokens from the credential management system and retrieving encrypted one or more credentials associated with one or more merchant accounts;
(e) extracting, by the backend system, one or more identified merchant systems associated with the one or more merchant accounts by at least decrypting the retrieved one or more encrypted credentials;
(f) modifying, by the backend system, a display of the list of merchant systems within the GUI based on the one or more identified merchant systems for the user to select from for changing the default POF;
(g) upon a selection of one or more merchant systems from the one or more identified merchant systems, transmitting, to the one or more merchant systems, the respective decrypted credentials to authenticate the user's credentials; and
(h) upon receiving an indication that the user's credentials for the user's one or more merchant accounts have been authenticated, transmitting instructions to the one or more merchant systems to change the default POF for the user's one or more merchant accounts to a payment account that the user selects to use.

2. The method of claim 1, wherein the list of merchant systems is generated and ranked using a machine learning algorithm trained model.

3. The method of claim 1, further comprising transmitting instructions to an issuer system to display an image, text, or other indication that the user has the account with the merchant, and wherein the issuer system is configured to manage the payment account that the user selects to use as the default POF.

4. The method of claim 3, wherein the default POF includes the payment account that is saved on the account associated with the user on the one or more merchant systems selected in (g) and used to make purchases by the user.

5. The method of claim 1, wherein changing the default POF includes changing from a first payment account to a second payment account on the one or more merchant systems selected in (f) for future transactions made by the user.

6. (canceled)

7. (canceled)

8. The method of claim 1, wherein (h) comprises transmitting an application programming interface (API) call to one or more endpoints associated with the one or more merchant systems selected in (g) to perform the change.

9. The method of claim 8, wherein transmitting the API call comprises transmitting payment account information related to the payment account to the one or more merchant systems selected in (g).

10. The method of claim 1, wherein the indication that the user's credentials for the user's one or more merchant accounts have been authenticated includes changes in cookies and/or URLs when the merchant is authenticated.

11. The method of claim 10, further comprising monitoring authentication of the credentials and providing error messages, captchas, or one-time password (OTP) requests to the user.

12. The method of claim 1, further comprising after the user's one or more merchant accounts have been authenticated, maintaining a persistent connection with the one or more merchant systems selected in (g) for collecting and storing transaction information in a database.

13. The method of claim 12, wherein the transaction information comprises item or Stock Keeping Unit (SKU)-level purchase information.

14. The method of claim 12, further comprising receiving a user input via a chat user interface indicative of a user intent for purchasing a product.

15. The method of claim 14, further comprising searching, using one or more search APIs provided by one or more merchant systems, one or more products and displaying an output including the one or more products via the chat user interface using a large language model.

16. The method of claim 15, wherein relevant transaction information associated with the user is used as context for generating the output.

17. The method of claim 15, wherein the output comprises a one-click button to purchase a product selected from the one or more products.

18. A computer system for managing and updating a default payment-account-on-file (POF) for a user on a merchant system, the computer system comprising:
a memory storing computer-readable instructions and at least one processor configured to execute the computer-readable instructions that are configured to perform operations comprising:
(a) generating, by a backend system, a list of merchant systems based at least in part on user profile data associated with the user and displaying, within a graphical user interface (GUI), the list of merchant systems, wherein the GUI is provided by the backend system;
(b) displaying, within the GUI provided by the backend system, a web-view prompting the user to log into a credential management account in a network session, wherein the credential management account is provided by a credential management system that is not part of the backend system;
(c) accessing the credential management account using session data associated with the network session to log into the credential management account;
(d) receiving, by the backend system, authentication cookies or tokens from the credential management system and retrieving encrypted one or more credentials associated with one or more merchant accounts;
(e) extracting one or more identified merchant systems associated with the one or more merchant accounts by at least decrypting the retrieved one or more encrypted credentials;
(f) modifying a display of the list of merchant systems within the GUI based on the one or more identified merchant systems for the user to select from for changing the default POF;
(g) upon a selection of one or more merchant systems from the one or more identified merchant systems, transmitting, to the one or more merchant systems, the respective decrypted credentials to authenticate the user's credentials; and
(h) upon receiving an indication that the user's credentials for the user's one or more merchant accounts have been authenticated, transmitting instructions to the one or more merchant systems to change the default POF for the user's one or more merchant accounts to a payment account that the user selects to use.

19. The system of claim 18, wherein the list of merchant systems is generated and ranked using a machine learning algorithm trained model.

20. The system of claim 18, wherein the operations further comprise transmitting instructions to an issuer system to display an image, text, or other indication that the user has the account with the merchant, and wherein the issuer system is configured to manage the payment account that the user selects to use as the default POF.
